(19) United States
(12) Patent Application Publication
(10) Pub. No.: US 2003/0090579 A1
(43) Pub. Date: May 15, 2003

(54) Mobile information terminal device and camera unit

(76) Inventors: Haruki Ohe, Tokyo (JP); Norifumi Nakagawa, Tokyo (JP); Kiyosi Toma, Tokyo (JP); Tomio Kurosu, Tokyo (JP)

Correspondence Address: Pillsbury Winthrop, Intellectual Property Group, East Tower 9th Floor, 1100 New York Avenue NW, Washington, DC, 20005-3918, US

(21) Appl. No.: 10/257,739

(22) PCT Filed: Feb. 18, 2002
(86) PCT No.: PCT/JP02/01344

(30) Foreign Application Priority Data
Feb. 19, 2001 (JP) 2001-41041
Feb. 19, 2001 (JP) 2001-41045
Feb. 26, 2001 (JP) 2001-49578

(51) Int. Cl. H04N 5/225

(52) U.S. Cl. 348/240.3; 348/373

(57) ABSTRACT

A portable information terminal device includes a monitor (11) on which information is displayed, a main body (10) on which the monitor (11) is mounted and by which the entire outline is defined, a CCD (24) disposed inside the main body (10) for photographing an object, and an optical unit (30) including a plurality of lenses (32,34) arranged in a direction of an optical axis and a driving mechanism (37) for performing variable-power driving while relatively moving the plurality of lenses so that a magnification of the object can be varied with respect to the CCD (24). Therefore, the object can be photographed in a wide range from a telephotographic side to a wide-angle side, and its image information can be transmitted and received through a communications system.

### TECHNICAL FIELD

This invention relates to a portable information terminal device, such as a portable telephone or a portable personal computer, provided with an optical unit capable of photographing an operator or scenes around the operator (the term “portable information terminal device” is hereinafter used as a general term for portable telephones, portable personal computers, etc.), and relates to a camera unit attachable/detachable to/from the portable information terminal device.

### BACKGROUND ART

A wireless communications system, such as wideband code division multiple access (W-CDMA), has been developed in recent years. A portable information terminal device (e.g., PDA), such as a portable telephone or a portable personal computer, which can transmit and receive image signals, has been developed correspondingly with an increase in data transfer rates resulting from this communications environment. As disclosed in, for example, Japanese Unexamined Patent Application Publication No. 2000-252144 and Japanese Unexamined Patent Application Publication No. 2000-253118, a camera unit (so-called mobile camera) with a post-fixed type or pre-fixed type monofocal optical unit is known as a camera unit used to transmit image signals.

However, the conventional camera unit is disadvantageous since, in the pre-fixed type, a size reduction cannot be smoothly achieved because of being always situated and fixed at a predetermined position, and, in the post-fixed type, a photographable state cannot be immediately reached when an operator wants to take a photograph.

Another disadvantage is the fact that the monofocal optical unit has difficulty in setting an arbitrary field angle since a constant field angle is always maintained, and, in order to change a photographic range, the distance between a to-be-photographed object and the optical unit (lens) needs to be constantly adjusted while changing the position of the portable information terminal device or the position of the object. This is inconvenient in handling.

Still another disadvantage is the fact that fingerprints, dust, etc., adhere to the surface of the lens since the optical unit is always exposed even in a state of no photography.

The present invention has been made in consideration of the foregoing circumstances. An object of the present invention is to provide a portable information terminal device provided with an optical unit that can perform wide-angle photography and telephotography without changing a photographic distance, that can be brought into a photographable state by easy operation, and that can prevent dust, etc., from adhering to the optical unit during no photography while achieving a size reduction and simplification of the device, and provide a camera unit attachable/detachable to/from the portable information terminal device.

### DISCLOSURE OF INVENTION

A portable information terminal device of the present invention has a display portion capable of displaying information, a main body on which the display portion is mounted and by which an outline is defined, an image pickup element for photographing a to-be-photographed object, and an optical unit that includes a plurality of lenses arranged in a direction of an optical axis and a driving mechanism for performing variable-power driving while relatively moving the plurality of lenses so as to allow a magnification of the object to become variable with respect to the image pickup element. According to this structure, since the optical unit is an optical system variable in power, a field angle becomes adjustable, and wide photography ranging from telephotography to wide-angle photography can be performed.

In the aforementioned structure, the optical unit may be formed so as to protrude from the exterior of the main body during photography and recede into the main body during no photography, or may be formed so as to perform variable-power operation in the interior of the main body during photography. According to this structure, in the former case, a moving range by the variable-power operation can be freely set, and, in the latter case, the optical unit does not appear on the exterior of the main body, and therefore can be prevented from colliding.

In the aforementioned structure, the driving mechanism may be formed so as to move the plurality of lenses from a dormant position to a photographic position of a wide-angle-side end through a photographic position of a telephotographic-side end. According to this structure, by the variable-power operation of the optical unit, continuous photography can be performed within a range from telephotography to wide-angle photography.

In the aforementioned structure, the driving mechanism may be formed so as to trip a switch, by which an electric-power supply to the image pickup element is turned on/off, when the plurality of lenses are situated at the photographic position of the telephotographic-side end. According to this structure, photography can be performed by the image pickup element in an interlocked manner with the variable-power driving of the driving mechanism, and instantaneous photography can be performed.

In the aforementioned structure, the driving mechanism may include an operating portion for manually performing variable-power driving. According to this structure, the variable-power operation of the optical unit is manually performed, thereby achieving a size reduction, a structural simplification, a cost reduction, etc.

In the aforementioned structure, the main body may include an extensible antenna, and the driving mechanism may include an interlocking mechanism for performing variable-power driving in an interlocked manner with the extension/contraction of the antenna. According to this structure, the optical unit can be caused to perform the variable-power operation and to return to the dormant position only by the extending/contracting operation of the antenna.

In the aforementioned structure, the main body may have a flipper openably and closably provided to cover at least a part of a body surface, and the driving mechanism may have an interlocking mechanism for performing variable-power driving in an interlocked manner with the opening/closing of the flipper. According to this structure, the optical unit can be caused to perform the variable-power operation and to return to the dormant position only by the opening/closing operation of the flipper.

Herein, the interlocking mechanism may include a connection member connected to a part of the driving mechanism and an interlocking spring for exerting an urging force by which the motion of the flipper is interlocked with the connection member. The driving mechanism may be formed so as to move the plurality of lenses from the dormant position to the photographic position of the wide-angle-side end through the photographic position of the telephotographic-side end. The interlocking mechanism may include a restriction member for restricting the movement of the connection member while overcoming the urging force of the interlocking spring when the plurality of lenses reach the photographic position of the telephotographic-side end in an interlocked manner with the opening of the flipper. The restriction member may be formed so that a restriction position where the movement of the connection member is restricted can be adjusted in a range from the photographic position of the telephotographic-side end to the photographic position of the wide-angle-side end. The restriction member may include a cam portion for exerting a cam action onto the connection member and an operating portion that is manually operated to be freely reciprocated. The flipper may be formed so as to cover the optical unit in a closed state.

In the aforementioned structure, the driving mechanism may include an electric actuator for electrically performing variable-power driving and a switch for turning the electric actuator on/off. According to this structure, the optical unit can be caused to perform the variable-power operation and to return to the dormant position only by the on/off operation of the switch.

Herein, the main body may include an extensible antenna, and the switch may be turned on/off in an interlocked manner with the extension/contraction of the antenna. The main body may have a flipper openably and closably provided to cover at least a part of the body surface, and the switch may be turned on/off in an interlocked manner with the opening/closing of the flipper.

In the aforementioned structure, there may be provided a camera unit that includes an image pickup element and an optical unit and is rotatably connected to the main body, and the optical unit may be formed so as to perform variable-power operation in the interior of the camera unit during photography. According to this structure, since the optical unit does not emerge from the exterior of the camera unit, the optical unit can be prevented from, for example, colliding, and a photographic direction can be arbitrarily selected by rotating it. This optical unit may be formed so as to emerge from the exterior of the camera unit during photography and to recede into the camera unit during no photography. Additionally, the camera unit may be rotatably connected to the main body so as to conceal the optical unit in a state in which the optical unit recedes. According to this structure, since the optical unit is concealed during no photography, it is possible to prevent the adhesion of dust, etc., onto the surface of the optical unit or prevent a break, etc., in the optical unit.

In the aforementioned structure, the main body may have a shielding member by which the front surface of the optical unit can be shielded and an interlocking mechanism for causing the shielding member to perform a shielding motion and an exposing motion in an interlocked manner with the operation of the driving mechanism. According to this structure, since the optical unit is protected during no photography, and it is interlocked with the driving mechanism during photography, functional reliability is secured without producing an off state of the timing at which the shielding member retreats so as to perform the exposing motion. Herein, the driving mechanism may have an operating portion for manually performing variable-power driving, and the shielding member may be formed so as to perform a shielding motion and an exposing motion in an interlocked manner with the operation of the operating portion. The driving mechanism may be formed so as to move a plurality of lenses from the dormant position to the photographic position of the wide-angle-side end through the photographic position of the telephotographic-side end. The interlocking mechanism may be formed so that the shielding member respondingly exposes the front surface of the optical unit before the plurality of lenses begin the variable-power operation from the dormant position, and respondingly shields the front surface of the optical unit after the plurality of lenses recede into the dormant position. The shielding member may be a shielding plate swingably supported around a predetermined axis, and the interlocking mechanism may have a swinging arm that swings around a predetermined axis in an interlocked manner with the operation of the driving mechanism, an interlocking spring for interlocking the motion of the swinging arm with the shielding plate and for exerting an urging force in a direction in which the front surface of the optical unit is exposed, and a restraining mechanism for restraining the shielding plate to move together with the swinging arm at predetermined timing during the shielding motion.

A camera unit of the present invention has an image pickup element for photographing a to-be-photographed object, an optical unit that includes a plurality of lenses arranged in a direction of an optical axis and a driving mechanism for performing variable-power driving while relatively moving the plurality of lenses so as to allow a magnification of the object to become variable with respect to the image pickup element, a connection terminal connected to the image pickup element for transmitting at least a signal regarding photographic information, and a connector portion attachable/detachable to/from a portable information terminal device.

According to this structure, since the optical unit is an optical system variable in power, a field angle becomes adjustable, and wide photography ranging from telephotography to wide-angle photography can be performed. Additionally, since the optical unit is an attachable/detachable type, it can be applied to various portable information terminal devices.

In the aforementioned structure, the driving mechanism may include an operating portion for manually performing variable-power driving. According to this structure, the variable-power operation of the optical unit is manually performed, and therefore the camera unit can achieve a cost reduction, a size reduction, and a structural simplification.

In the aforementioned structure, the driving mechanism may include an electric actuator for electrically performing variable-power driving and a switch for turning the electric actuator on/off. According to this structure, the optical unit can be caused to perform the variable-power operation and to return to the dormant position only by the on/off operation of the switch.

### BRIEF DESCRIPTION OF DRAWINGS

FIGS. 1A and 1B are a front view and a side view, respectively, showing the exterior of a portable telephone according to the present invention.

FIG. 2 is a sectional view showing a state in which an optical unit is situated at a retracted, dormant position.

FIG. 3 is a sectional view showing a state in which the optical unit emerges and is situated at the photographic position of a telephotographic-side end.

FIG. 4 is a sectional view showing a state in which the optical unit further emerges and is situated at the photographic position of a wide-angle-side end.

FIG. 5 is a side view for explaining the operation of a cam plate serving as a driving mechanism with which an operating portion is formed integrally.

FIGS. 6A and 6B are an external front view and a sectional view seen from the rear, respectively, showing the structure of the camera unit.

FIG. 7 is a perspective view showing the exterior of a portable personal computer according to the present invention.

FIGS. 8A and 8B show another embodiment of the portable telephone according to the present invention, FIG. 8A being an exploded perspective view showing a mounting structure when the camera unit is modularized, FIG. 8B being a perspective view when the camera unit is mounted.

FIGS. 9A and 9B are views for explaining the motion of the portable telephone shown in FIGS. 8A and 8B, FIG. 9A being a front view showing a state in which the optical unit is concealed and housed, FIG. 9B being a front view showing a state in which the optical unit is exposed.

FIGS. 10A and 10B show another embodiment of the portable personal computer according to the present invention, FIG. 10A being a perspective view showing a state in which the optical unit is concealed and housed, FIG. 10B being a perspective view showing a state in which the optical unit is exposed.

FIG. 11 is a front view showing another embodiment of the portable telephone according to the present invention.

FIGS. 12A, 12B, and 12C are views for explaining the manipulation of the portable telephone shown in FIG. 11, FIG. 12A being a side view showing a state in which an antenna is contracted, and the optical unit is situated at a retracted, dormant position, FIG. 12B being a side view showing a state in which the antenna is slightly extended, and the optical unit is situated at the photographic position of the telephotographic-side end, FIG. 12C being a side view showing a state in which the antenna is further extended, and the optical unit is situated at the photographic position of the wide-angle-side end.

FIG. 13 is a side view for explaining the motion of a cam plate serving as a driving mechanism that is interlocked with the antenna.

FIGS. 14A and 14B are an external front view and a sectional view seen from the rear, respectively, showing the structure of the camera unit.

FIGS. 15A and 15B are a front view and a side view, respectively, showing another embodiment of the portable telephone according to the present invention.

FIG. 16 is a sectional view of the camera unit seen from the rear.

FIG. 17 is a plan view of a cam plate that serves as a part of the driving mechanism.

FIG. 18 is a perspective view showing the interlocking mechanism of a flipper and the driving mechanism.

FIGS. 19A, 19B, 19C are side views for explaining the manipulation of the portable telephone shown in FIG. 15, FIG. 19A being a side view showing a state in which the flipper is closed, and the optical unit is situated at the retracted, dormant position, FIG. 19B being a side view showing a state in which the flipper is opened, and the optical unit is situated at the photographic position of the telephotographic-side end, FIG. 19C being a side view showing a state in which a restriction member is moved, and the optical unit is situated at the photographic position of the wide-angle-side end.

FIGS. 20A and 20B are a front view and a side view, respectively, showing another embodiment of the portable telephone according to the present invention.

FIG. 21 is a sectional view of the camera unit seen from the rear.

FIG. 22 is a plan view of a cam plate that serves as a part of the driving mechanism.

FIG. 23 is a plan view showing the interlocking mechanism of a shielding member and the driving mechanism.

FIG. 24 is an external perspective view showing another embodiment of the portable personal computer according to the present invention.

FIGS. 25A and 25B are a front view and a side view, respectively, showing another embodiment of the portable telephone according to the present invention.

FIG. 26 is a front view showing a state in which the camera unit is rotated so that the optical unit is situated at a forward position in the portable telephone shown in FIGS. 25A and 25B.

FIGS. 27A and 27B are a front view and a side view, respectively, showing another embodiment of the portable telephone according to the present invention.

FIG. 28 is a front view showing a state in which the camera unit is rotated so that the optical unit is situated at a forward position in the portable telephone shown in FIGS. 27A and 27B.

FIG. 29 is a sectional view of the camera unit seen from the rear.

FIG. 30 is a plan view of a cam plate that serves as a part of the driving mechanism.

FIG. 31 is an external perspective view showing an embodiment of a camera unit according to the present invention, the camera unit being attachable/detachable to/from the main body of a portable information terminal device.

FIG. 32 shows the internal structure of the camera unit, and is a sectional view showing a state in which the optical unit is situated at a retracted, dormant position.

FIG. 33 shows the internal structure of the camera unit, and is a sectional view showing a state in which the optical unit emerges, and is situated at the photographic position of a telephotographic-side end.

FIG. 34 shows the internal structure of the camera unit, and is a sectional view showing a state in which the optical unit further emerges, and is situated at the photographic position of a wide-angle-side end.

FIG. 35 is a side view for explaining the motion of a cam plate that serves as a driving mechanism with which an operating portion is formed integrally.

FIGS. 36A and 36B are an external front view and a sectional view seen from the rear, respectively, showing the structure of the camera unit.

### BEST MODE FOR CARRYING OUT THE INVENTION

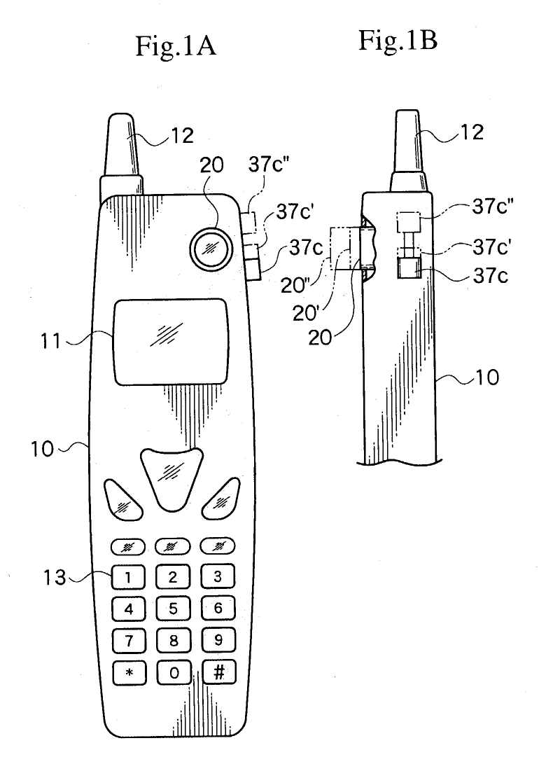

Embodiments of the present invention will hereinafter be described with reference to the attached drawings. FIGS. 1A and 1B through FIGS. 6A and 6B show an embodiment of a portable information terminal device (herein, a portable telephone) according to the present invention.

As shown in FIGS. 1A and 1B, the portable telephone according to this embodiment includes a main body 10 by which an outline is defined, a display portion (liquid crystal monitor) 11 that is disposed on the surface of the main body 10 and that can display various information about transmission and reception, an antenna 12, various operating buttons 13, a camera unit 20 for photographing a to-be-photographed object, an operating portion 37c for manually performing a variable-power adjustment of the camera unit 20 (i.e., optical unit 30), and a signal transmitting/receiving portion (not shown) for performing various signal processings that include the antenna 12 as a part of its constituent element and that is disposed inside the main body 10.

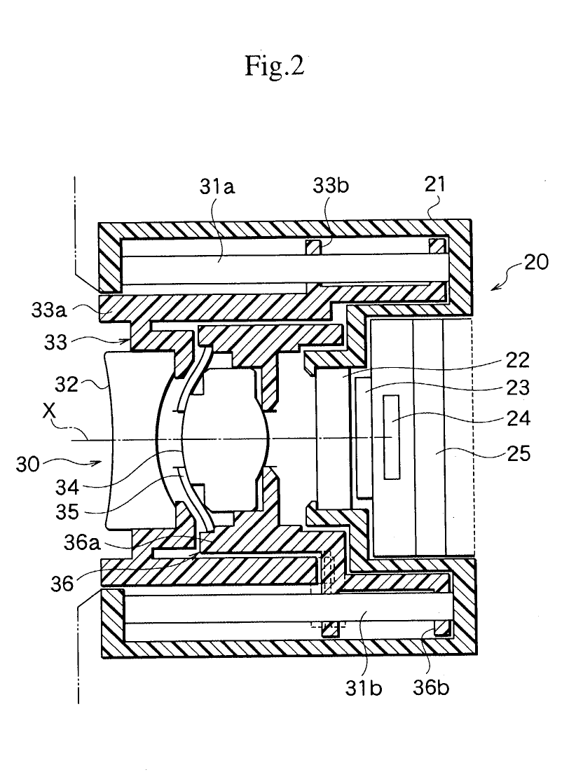

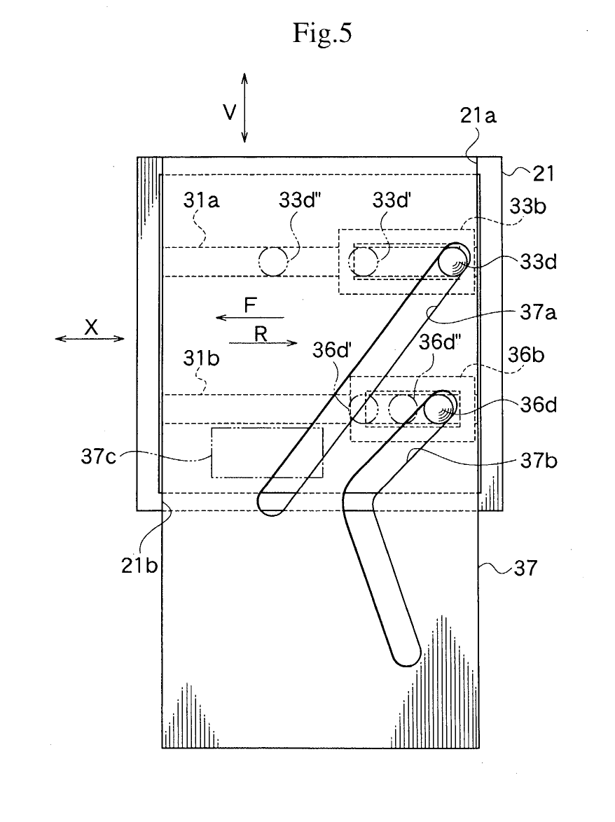

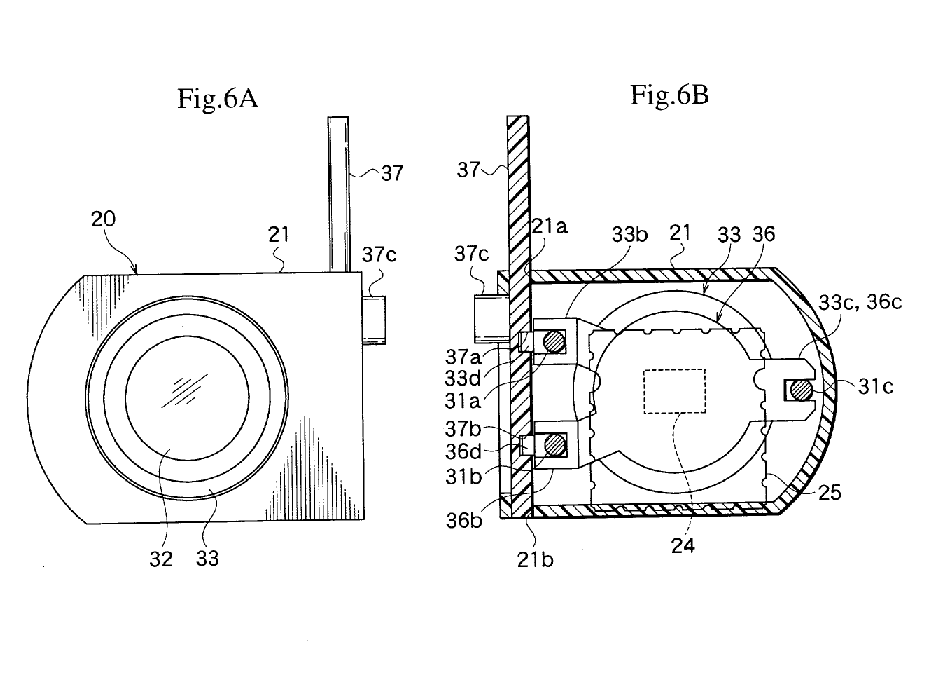

As shown in FIG. 2, FIG. 5, FIGS. 6A and 6B, the camera unit 20 is made up of an optical unit 30 supported by a case 21, a crystal filter 22, such as an infrared-ray filter or a low-pass filter, a faceplate 23, a CCD 24 as an image pickup element, and a circuit board 25.

The optical unit 30 is made up of, as shown in FIG. 5, FIGS. 6A and 6B, three guide shafts 31a, 31b, and 31c that are fixed in the case 21 and extend in the direction of the optical axis X, and, as shown in FIG. 2, a first lens frame 33 that is guided by the guide shafts 31a to 31c and holds a concave lens 32, a second lens frame 36 that is guided by the guide shafts 31a to 31c and holds a convex lens 34 and an aperture plate 35, and a cam plate 37 for driving the first lens frame 33 and the second lens frame 36 in the direction of the optical axis X.

The first lens frame 33 (concave lens 32) and the second lens frame 36 (convex lens 34) are relatively moved in the direction of the optical axis X, and therefore the magnification of the object is varied with respect to the CCD 24, and focusing operation is performed. In other words, a variable-power lens optical system is made up of the concave lens 32, the convex lens 34, etc.

As shown in FIG. 2, FIGS. 6A and 6B, the first lens frame 33 has a body tube portion 33a for holding the concave lens 32. A first connection portion 33b and a second connection portion 33c are formed integrally with the body tube portion 33a. The first connection portion 33b is slidably connected to the guide shaft 31a, and the second connection portion 33c is slidably connected to the guide shaft 31c. A pin 33d is formed integrally with a part of the first connection portion 33b, and the pin 33d is slidably connected to a cam groove 37a described later.

As shown in FIG. 2, FIGS. 6A and 6B, the second lens frame 36 has a body tube portion 36a for holding the convex lens 34. A first connection portion 36b and a second connection portion 36c are formed integrally with the body tube portion 36a. The first connection portion 36b is slidably connected to the guide shaft 31b, and the second connection portion 36c is slidably connected to the guide shaft 31c. A pin 36d is formed integrally with a part of the first connection portion 36b, and the pin 36d is slidably connected to a cam groove 37b described later.

The first connection portion 33b of the first lens frame 33 and the first connection portion 36b of the second lens frame 36 each have a through-hole through which they are closely fitted onto the guide shafts 31a and 31b, respectively. The second connection portion 33c of the first lens frame 33 and the second connection portion 36c of the second lens frame 36 each have, as shown in FIGS. 6A and 6B, a U-shaped groove formed so as to pinch the guide shaft 31c. Due to the through-hole and the U-shaped groove, the first lens frame 33 and the second lens frame 36 are smoothly guided along the guide shafts 31a to 31c in the direction of the optical axis X without rattling.

As shown in FIG. 5, FIGS. 6A and 6B, the cam plate 37 is a rectangular flat plate, and is reciprocatively guided in the upward/downward direction (direction “V”) by upper and lower rectangular holes 21a and 21b formed in the case 21. The cam plate 37 has, in its side face, a first cam groove 37a formed linearly and slantingly and a second cam groove 37b shaped substantially like “<”.

An operating portion 37c that is manually operated is formed integrally with the side face of the cam plate 37, and an end side of the operating portion 37c is exposed on the exterior of the main body 10. Therefore, when an operator grips the operating portion 37c and moves it in the upward/downward direction (direction of arrow “V”), the cam plate 37 moves upward and downward correspondingly, and the first cam groove 37a and the second cam groove 37b exert a cam action onto the first lens frame 33 and the second lens frame 36, respectively.

The first and second cam grooves 37a and 37b of the cam plate 37, the pin 33d of the first lens frame 33, the pin 36d of the second lens frame 36, etc., compose a driving mechanism by which the optical unit 30 is moved in the direction from the telephotographic-side photographic position to the wide-angle-side photographic position or in the opposite direction in accordance with the moving operation of the operating portion 37c, or is made to retract into the main body 10.

In other words, the optical unit 30 is made up of a plurality of lenses 32 and 34, the driving mechanism by which the plurality of lenses 32 and 34 are relatively moved in the direction of the optical axis “X”, and other components.

The cam plate 37 has a part (not shown) that is engaged/disengaged with/from a switch (not shown) for turning a power source, which supplies electric power to the CCD 24, on/off. When this part reaches a photographic position (i.e., photographic position at the telephotographic-side end) by a predetermined amount upward from the position shown in FIG. 5, the part is engaged with the switch so as to turn the switch on, and therefore electric power begins to be supplied to the CCD 24. On the other hand, when the cam plate 37 is moved in the opposite direction, the switch is turned off, and therefore electric power ceases to be supplied to the CCD 24.

Next, a description will be given of the operation of the portable telephone according to this embodiment.

First, in a non-operating state, the operating portion 37c is situated at a lower end as shown in FIGS. 1A and 1B, and FIG. 2, and the camera unit 20 (optical unit 30) is at the dormant position (i.e., in a retracted state) to which it has receded from the surface of the main body 10. At this time, the cam plate 37 is situated at the movable end downward in the V direction as shown in FIG. 5.

When the operator moves the operating portion 37c to the position (operating portion 37c′) shown by the alternate long and two short dashed line of FIGS. 1A and 1B in this state, the cam plate 37 is moved upward in FIG. 5 in an interlocked manner with its movement. Accordingly, the pin 33d of the first lens frame 33 is moved forward (direction of arrow “F”) by the cam action of the first cam groove 37a, and arrives at the position of the pin 33d′ in FIG. 5. On the other hand, the pin 36d of the second lens frame 36 is moved forward (direction of arrow “F”) by the cam action of the second cam groove 37b, and arrives at the position (in the vicinity of the inflection point of the second cam groove 37b) of the pin 36d′.

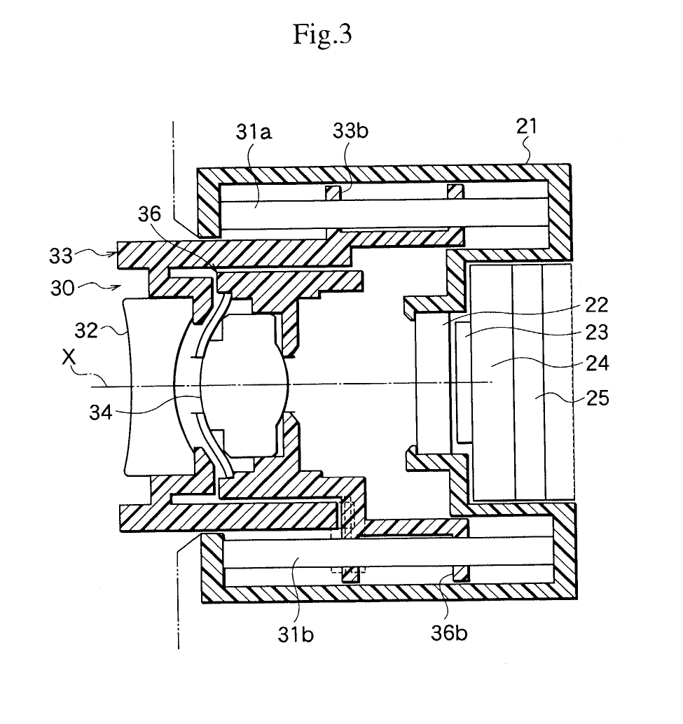

At this moment, the optical unit 30 (i.e., the body tube 33a holding the concave lens 32) is situated at the position (camera unit 20′) shown by the alternate long and two short dashed line of FIG. 1B, and, as shown in FIG. 3, it slightly emerges from the surface of the main body 10, and is situated at the photographic position of the telephotographic-side end. Simultaneously, a part of the cam plate 37 is engaged with the switch so as to turn it on, and electric power begins to be supplied to the CCD 24. Therefore, photography can be immediately performed through the camera unit 20 (optical unit 30 and CCD 24).

While the operator is moving the operating portion 37c, a positioning mechanism (not shown) is actuated at the photographic position of the telephotographic-side end, and resistance to the moving operation increases, so that it becomes impossible to move the operating portion 37c with the same operating force. Therefore, at that moment, the optical unit 30 is positioned at the photographic position of the telephotographic-side end.

The positioning mechanism can be structured so that, for example, positioning is performed by allowing a semicircular projection of a spring always pressed against the side face of the cam plate 37 to enter a groove formed in the side face of the cam plate 37.

When the operator further moves the operating portion 37c with an operating force that can release the positioning force of the positioning mechanism from the photographic position of the telephotographic-side end to the position (operating portion 37c″) shown by the alternate long and two short dashed line of FIGS. 1A and 1B, the cam plate 37 is further moved upward in FIG. 5 in an interlocked manner with its movement. As a result, the pin 33d of the first lens frame 33 is moved forward (direction of arrow “F”) by the cam action of the first cam groove 37a, and arrives at the position of the pin 33d″ in FIG. 5. On the other hand, the pin 36d of the second lens frame 36 is moved rearward (direction of arrow “R”) by the cam action of the second cam groove 37b, and arrives at the position of the pin 36d″ in FIG. 5.

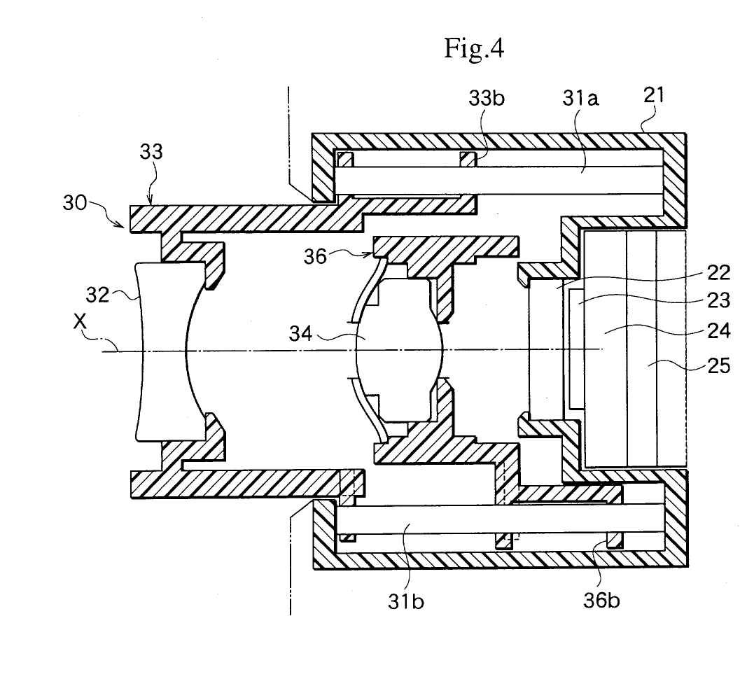

At this moment, the optical unit 30 (i.e., the body tube 33a holding the concave lens 32) is situated at the position (camera unit 20″) shown by the alternate long and two short dashed line of FIG. 1B, and, as shown in FIG. 4, it further emerges from the surface of the main body 10, and is situated at the photographic position of the wide-angle-side end.

On the other hand, when the operator moves the operating portion 37c in the opposite direction (downward), the optical unit 30 arrives at the photographic position of the telephotographic-side end from the photographic position of the wide-angle-side end. At this moment, a part of the cam plate 37 is actuated to turn the switch off, and electric power ceases to be supplied to the CCD 24, and the optical unit 30 arrives at the dormant position and reaches a retracted state.

The optical unit 30 is situated at the photographic position only by permitting the operator to move the operating portion 37c in this way, and it becomes possible to perform photography through the CCD 24. Additionally, it is possible to continuously perform variable-power operation from the photographic position of the telephotographic-side end to the photographic position of the wide-angle-side end. Therefore, an annoying preparatory operation does not need to be performed for photography, and a photographable state can be immediately reached merely by moving the operating portion 37c. Therefore, a time lag that is spent until the photographable state is reached can be reduced as much as possible, and a portable telephone excellent in convenience can be achieved. Additionally, since the switching between the telephotography and the wide-angle photography can be continuously performed only by appropriately adjusting a movement quantity of the operating portion 37c, there is no need to annoyingly change a photographic distance when a photographic range is changed.

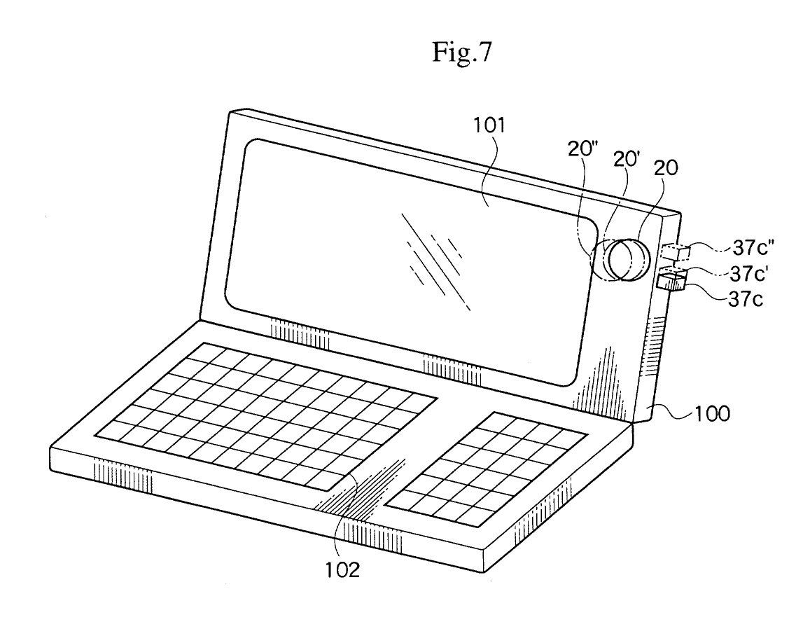

FIG. 7 shows another embodiment of the portable information terminal device (herein, a portable personal computer) according to the present invention. As shown in FIG. 7, the portable personal computer includes a main body 100 by which an outline is defined, a display portion (liquid crystal monitor) 101 that is disposed on the surface of the main body 100 and that can display various information, various operating buttons 102, the aforementioned camera unit 20 for photographing a to-be-photographed object, the operating portion 37c for manually performing a variable-power adjustment of the camera unit 20, and an information signal processing portion (not shown) disposed inside the main body 100 for processing various information signals. Since the camera unit 20 (optical unit 30, etc.), the operating portion 37c, etc., are the same as in the aforementioned embodiment, a description of these is omitted here.

Also in this portable personal computer, the camera unit 20 (optical unit 30) can be moved from the retracted, dormant position to the photographic position (camera unit 20′) of the telephotographic-side end and further to the photographic position (camera unit 20″) of the wide-angle-side end only by moving the operating portion 37c to the position (operating portion 37c′ and operating portion 37c″) shown by the alternate long and two short dashed line as shown in FIG. 7. As a result, the switching between telephotography and wide-angle photography can be continuously performed, and photography can be performed at the desired photographic range (field angle)without changing the photographic position.

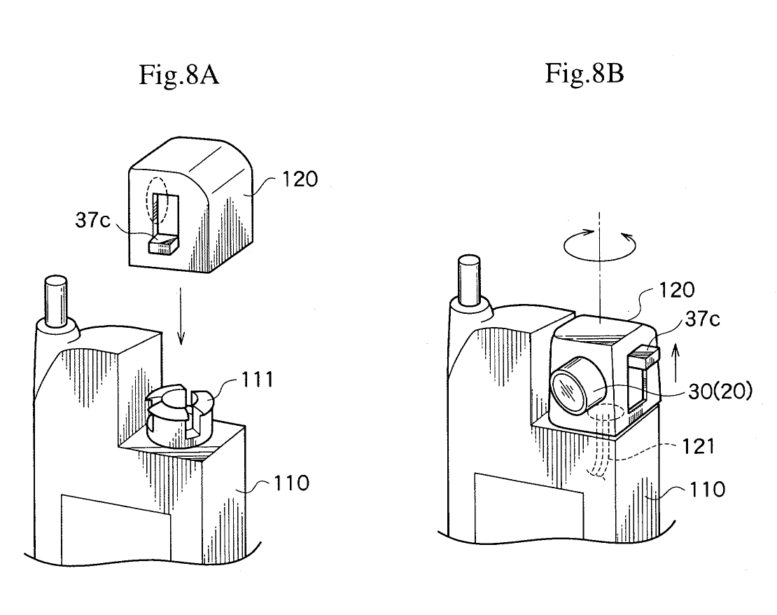

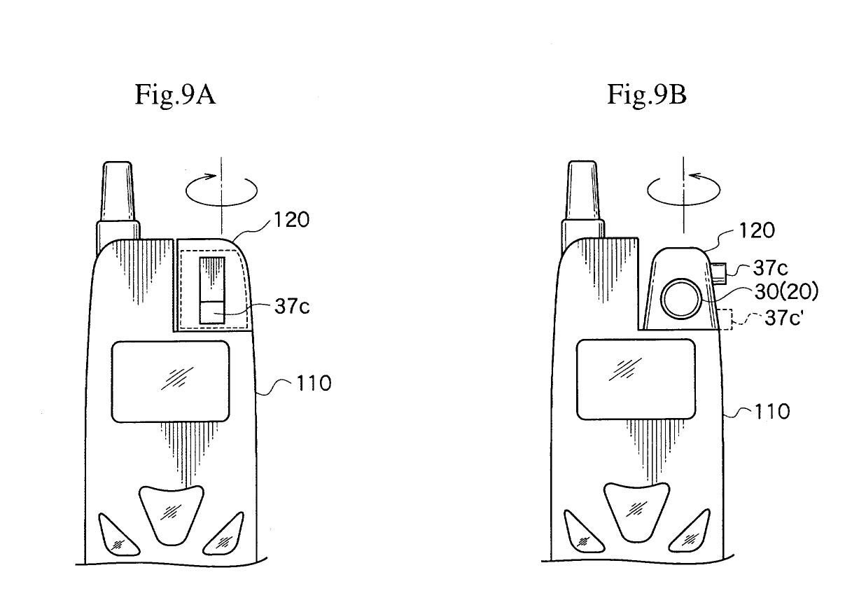

FIGS. 8A and 8B, and FIGS. 9A and 9B show still another embodiment of the portable information terminal device according to the present invention. This portable telephone is provided with the camera unit 20 that can be concealed. In more detail, as shown in FIGS. 8A and 8B, a camera unit 120 contains the aforementioned optical unit 30, and is different only in the case from the aforementioned camera unit 20. The camera unit 120 is formed independently of a main body 110, and is modularized. This is rotatably (oscillatably) supported at a connection part.

As shown in FIG. 8A, the main body 110 has a pipe-like projection 111 for connection, which is connected to a connection part formed at the lower end of the camera unit 120. The front end of the projection 111 is shaped like a bayonet, and, when it is rotated in a rotational position, which is not used typically, while inserting the camera unit 120, a fall-off stopping function is activated, and the camera unit 120 is rotatably connected to the main body 110. As shown in FIG. 8B, wires 121 of the camera unit 120 are led to the interior of the main body 110 through the interior of the projection 111.

The operation of this portable telephone will be described. In the state of not being used, the camera unit 120 is rotated so as to situate the operating portion 37c forward as shown in FIG. 9A, and the optical unit 30 is at a concealed, housed position while facing the inside of the main body 110.

When photography is performed by use of the camera unit 120, the camera unit 120 is rotated so as to situate the operating portion 37c at the right side face as shown in FIG. 9B. Therefore, the optical unit 30 is brought into an exposed state. Thereafter, in order to move the optical unit 30 situated at the retracted, dormant position to a photographic position, the operating portion 37c is moved upward (the operating portion 37c′ shown by the alternate long and two short dashed line is at the dormant position, and the operating portion 37c shown by the solid line is at the photographable position; see FIG. 8B). Therefore, it becomes possible to perform telephotography or wide-angle photography.

On the other hand, in order to end photography, the operating portion 37c is lowered, and the optical unit 30 is retracted. Thereafter, the camera unit 120 is rotated, and is caused to return to the former, housed position shown in FIG. 9A so as to reach a concealed state. Thus, flaws, fingerprints, dust, etc., can be prevented from occurring in or adhering onto the surface of the lens by concealing the optical unit 30 in a state of not being used.

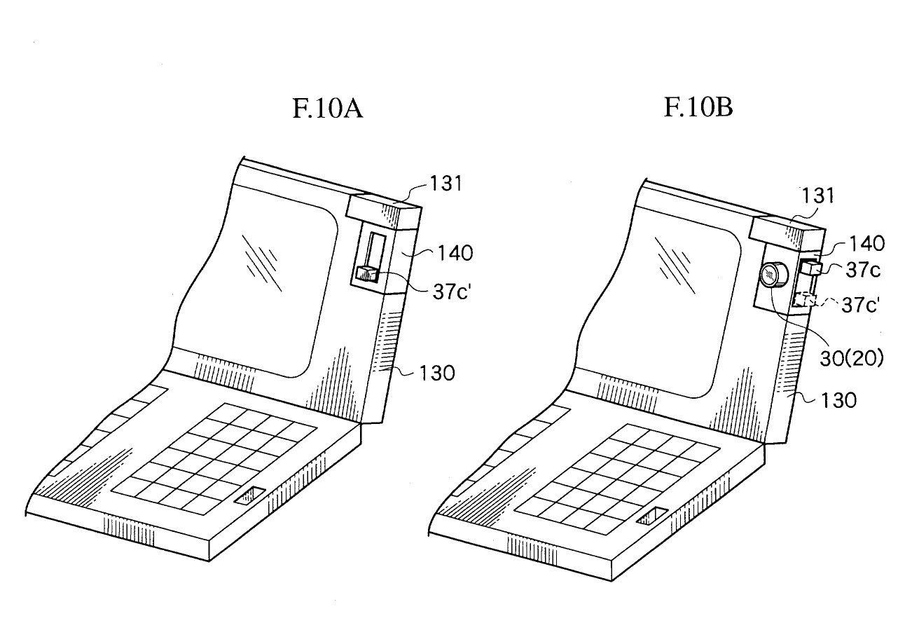

FIGS. 10A and 10B show an embodiment in which the same concealable camera unit as in the embodiment shown in FIGS. 8A and 8B, and FIG. 9A and 9B is applied to a portable personal computer. That is, the same connecting projection (not shown) as in the aforementioned embodiment is formed at the upper right edge of a main body 130, and a camera unit 140 is rotatably connected as shown in FIGS. 10A and 10B. Herein, in order to facilitate the attachment of the camera unit 140, the main body 130 has a separating portion 131 at its upper end. Since the operation and the advantageous effect in this embodiment are the same as in the aforementioned embodiment, a description thereof is omitted here.

In the aforementioned embodiments, the cam action of the cam plate 37 has been employed as a driving mechanism by which the magnification of the optical unit 30 becomes variable. However, without being limited to this, the present invention can employ other mechanisms.

Additionally, in the aforementioned embodiments, the operating portion 37c, which is formed to protrude from the main bodies 10, 100, 110, and 130 and which linearly moves, has been employed as a manual-operating portion. However, the variable-power operation of the optical unit 30 may be performed such that a rack is formed on the side face of the cam plate 37, and a pinion to be engaged with this rack is rotatably formed in the main body so as to serve as an operating portion, and the pinion (operating portion) is rotated, or, alternatively, may be performed such that the pinion is connected to an electric actuator, such as a motor, and is electrically driven by the on/off operation of a switch.

Still additionally, in the aforementioned embodiments, the two lenses of the concave lens 32 and the convex lens 34 have been employed as variable-power lenses that compose the optical unit 30. However, without being limited to this, more lenses can be employed.

Still additionally, in the aforementioned embodiments, the projection 111 for connection is provided to dispose the concealable camera units 120 and 140 and rotatably support them. However, without being limited to this structure, other structures can be employed if they are rotatably and concealably supported.

As described above, according to these portable information terminal devices, the optical unit 30 that composes the camera unit 20 is formed to serve as a variable-power lens optical system by which variable-power photography can be performed, and therefore photography in a wide range from the telephotographic side to the wide-angle side can be performed only by adjusting the optical unit 30 without changing a photographic distance.

Additionally, since the hand-operated operating portion 37c is disposed in the main bodies 10, 100, 110, and 130 in order to perform the variable-power adjustment of the optical unit 30, the switching between telephotography and wide-angle photography can be continuously performed only by moving the operating portion 37c while achieving a size reduction, a structural simplification, etc.

Still additionally, since the electric-power supply to the CCD 24 is turned on/off in an interlocked manner with the moving operation of the operating portion 37c, instantaneous photography can be performed, and, for example, a time lag that is spent until a photographable state is reached can be reduced.

Still additionally, since the camera units 120 and 140 are modularized and are rotatably supported, and since the optical unit 30 is concealed in the state of not being used, flaws, fingerprints, dust, etc., can be prevented from occurring in or adhering onto the surface of the lens.

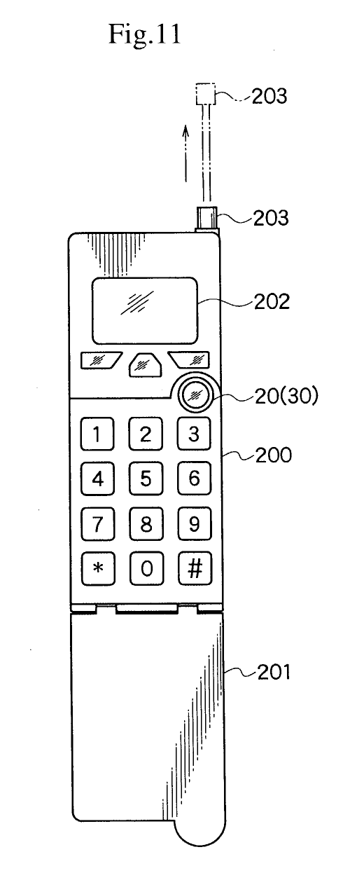

FIG. 11 through FIGS. 14A and 14B show another embodiment of the portable information terminal device (herein, portable telephone) according to the present invention. Since the camera unit 20 (optical unit 30, etc.) is the same as that shown in FIG. 2 through FIG. 4 mentioned above, a description thereof is omitted here.

As shown in FIG. 11, this portable telephone includes a main body 200 by which an outline is defined, a flipper 201 for covering an operating portion, etc., disposed on the surface of the main body 200, a display portion (liquid crystal monitor) 202 that can display various information about transmission and reception, an extensible antenna 203, a signal transmitting/receiving portion (not shown) for performing various signal processing that includes the antenna 203 as a part of its constituent element and that is disposed inside the main body 200, and the aforementioned camera unit 20 for photographing a to-be-photographed object.

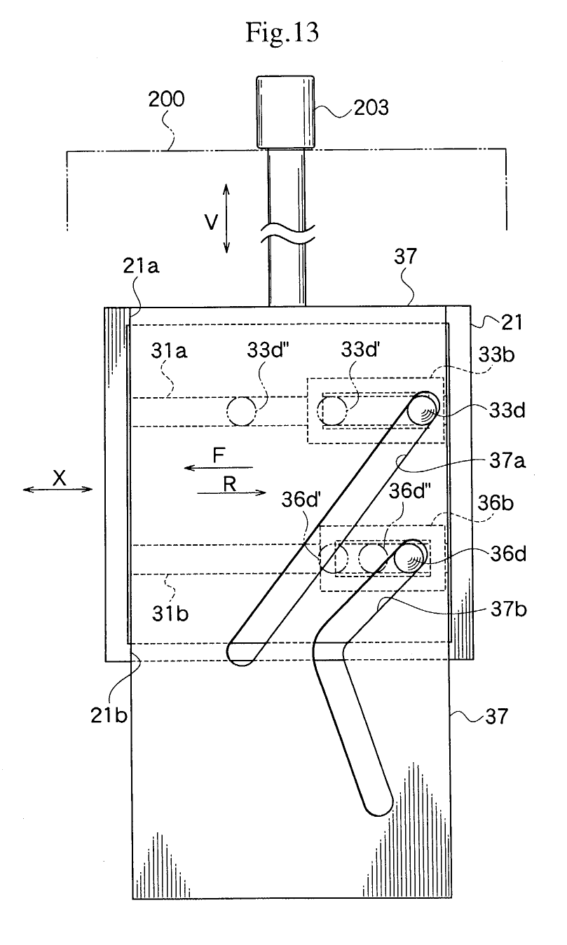

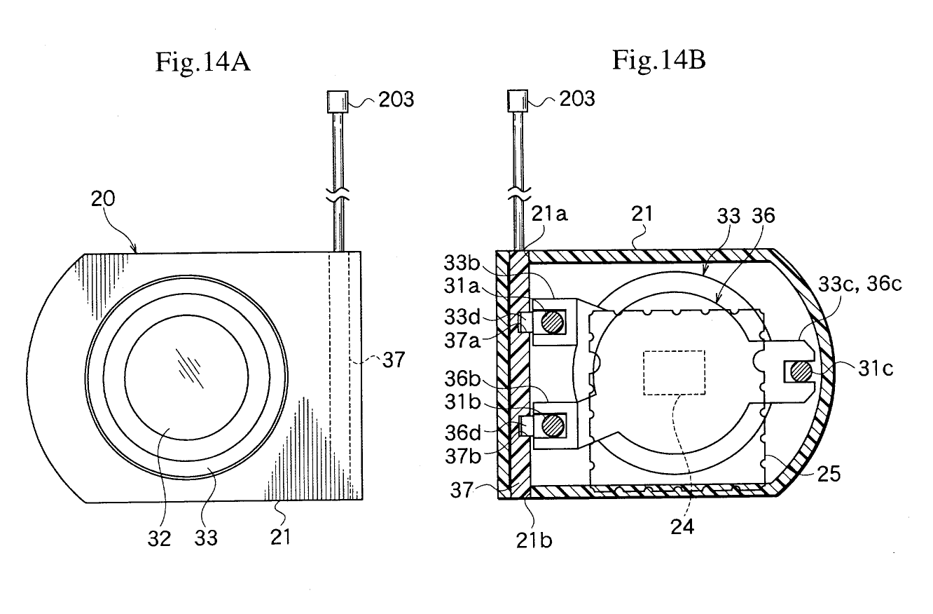

As shown in FIG. 13, and FIGS. 14A and 14B, the cam plate 37 is a rectangular flat plate, and is reciprocatively guided in the upward/downward direction (direction “V”) by upper and lower rectangular holes 21a and 21b formed in the case 21. The cam plate 37 has, in its side face, a first cam groove 37a formed linearly and slantingly and a second cam groove 37b shaped substantially like “<”. The antenna 203, instead of the operating portion 37c shown in FIG. 4, is connected to the upper end of the cam plate 37, and, when an operator grips the antenna 203 and moves it in the upward/downward direction (direction of arrow “V”), the cam plate 37 moves upward and downward correspondingly. That is, an interlocking mechanism by which the cam plate 37 is interlocked with the extending/contracting operation of the antenna 203 is formed by a connection structure of the antenna 203 and the cam plate 37.

The cam plate 37 has a part (not shown) that is engaged/disengaged with/from a switch (not shown) for turning a power source, which supplies electric power to the CCD 24, on/off. When this part reaches a photographic position (i.e., photographic position at the telephotographic-side end) by a predetermined amount upward from the position shown in FIG. 13, the part is engaged with the switch so as to turn the switch on, whereby electric power begins to be supplied to the CCD 24. On the other hand, when the cam plate 37 is moved in the opposite direction, the switch is turned off, whereby electric power ceases to be supplied to the CCD 24.

Next, a description will be given of the operation of the portable telephone according to this embodiment.

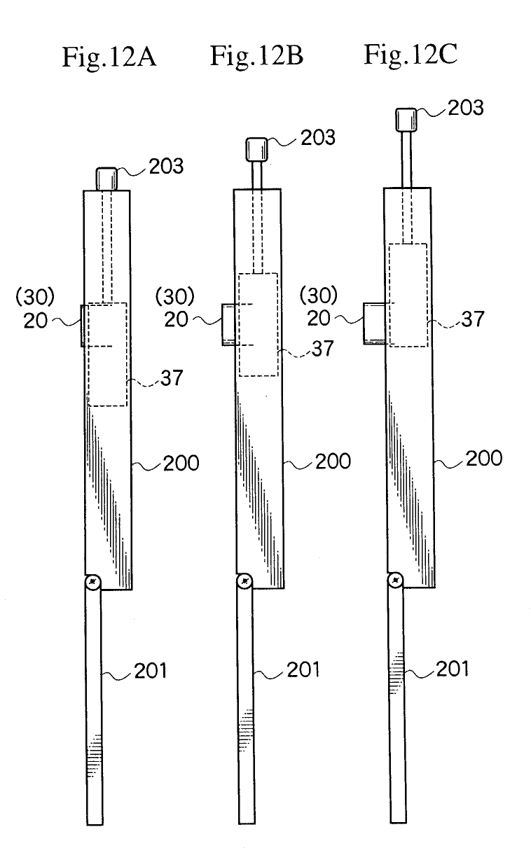

First, in a non-operating state, the antenna 203 is contracted and is housed in the main body 200 as shown in FIG. 12A, and the camera unit 20 (optical unit 30) is at the dormant position (i.e., in a retracted state) to which it has receded from the surface of the main body 200 as shown in FIG. 2. At this time, the cam plate 37 is situated at the movable end downward in the V direction as shown in FIG. 13.

When the operator extends the antenna 203 to the position shown in FIG. 12B in this state, the cam plate 37 is moved upward in FIG. 13 in an interlocked manner with its movement. Accordingly, the pin 33d of the first lens frame 33 is moved forward (direction of arrow “F”) by the cam action of the first cam groove 37a, and arrives at the position of the pin 33d′ in FIG. 13. On the other hand, the pin 36d of the second lens frame 36 is moved forward (direction of arrow “F”) by the cam action of the second cam groove 37b, and arrives at the position (in the vicinity of the inflection point of the second cam groove 37b) of the pin 36d′ in FIG. 13.

At this moment, the optical unit 30 (i.e., the body tube 33a holding the concave lens 32) slightly emerges from the surface of the main body 200, and is situated at the photographic position of the telephotographic-side end as shown in FIG. 12B and FIG. 3. Simultaneously, a part of the cam plate 37 is engaged with the switch so as to turn it on, and electric power begins to be supplied to the CCD 24. Therefore, photography can be immediately performed.

While the operator is extending the antenna 203, a positioning mechanism (not shown) is actuated at the photographic position shown in FIG. 12B, and resistance to the extending operation increases, so that it becomes impossible to extend the antenna 203 with the same extending force. Therefore, at that moment, the optical unit 30 is situated at the photographic position of the telephotographic-side end.

The positioning mechanism can be structured so that, for example, positioning is performed by allowing a semicircular projection of a spring always pressed against the outer circumferential surface of the antenna 203 to enter a groove (annular groove) formed in the outer periphery of the antenna 203.

When the operator further extends the antenna 203 with an extending force that can release the positioning force of the positioning mechanism from the photographic position of the telephotographic-side end to the position shown in FIG. 12C, the cam plate 37 is further moved upward in FIG. 13 in an interlocked manner with its movement. As a result, the pin 33d of the first lens frame 33 is moved forward (direction of arrow “F”) by the cam action of the first cam groove 37a, and arrives at the position of the pin 33d″ in FIG. 13. On the other hand, the pin 36d of the second lens frame 36 is moved rearward (direction of arrow “R”) by the cam action of the second cam groove 37b, and arrives at the position of the pin 36d″ in FIG. 13. At this moment, the optical unit 30 (i.e., the body tube 33a holding the concave lens 32) further emerges from the surface of the main body 200, and is situated at the photographic position of the wide-angle-side end as shown in FIG. 12C and FIG. 4.

On the other hand, when the operator contracts the antenna 203 in the opposite direction so as to house it into the main body 200, the optical unit 30 arrives at the photographic position of the telephotographic-side end from the photographic position of the wide-angle-side end. At this moment, a part of the cam plate 37 is actuated to turn the switch off, and electric power ceases to be supplied to the CCD 24, and the optical unit 30 arrives at the dormant position and reaches a retracted state.

In the aforementioned embodiment, a variable-power optical system has been employed as the optical unit 30. However, even if a monofocal optical unit is employed, a smooth shift to a photographing motion can be accomplished by situating the optical unit at a photographic position so as to be interlocked with the antenna 203 and by actuating the optical unit in an interlocked manner with the ON/OFF of the switch.

Additionally, in the aforementioned embodiment, the cam action of the cam plate 37 has been employed as a driving mechanism by which the power of the optical unit 30 becomes variable. However, without being limited to this, other mechanisms can be employed.

Still additionally, in the aforementioned embodiment, a description has been given of the structure in which the cam plate 37 is driven in an interlocked manner with the extension/contraction of the antenna 203. However, it may be electrically driven by connecting a pinion to be engaged with a rack formed on the cam plate 37 to an electric actuator, such as a motor, and by turning the switch on/off in an interlocked manner with the extension/contraction of the antenna 203.

Still additionally, in the aforementioned embodiment, the portable telephone has been shown as a portable information terminal device to which the present invention is applied. However, without being limited to this, the present invention can be applied to a portable personal computer provided with an antenna, for example.

As described above, according to this portable information terminal device, the optical unit 30 is situated at the photographic position only by permitting the operator to extend and contract the antenna 203, and it becomes possible to perform photography through the CCD 24. Additionally, it is possible to continuously perform variable-power operation from the photographic position of the telephotographic-side end to the photographic position of the wide-angle-side end.

Therefore, an annoying preparatory operation does not need to be performed for photography, and a photographable state can be immediately reached merely by extending the antenna 203. Therefore, a time lag that is spent until the photographable state is reached can be reduced as much as possible, and a portable telephone excellent in convenience can be achieved. Additionally, since the switching between the telephotography and the wide-angle photography can be continuously performed only by appropriately adjusting an extension amount of the antenna 203, there is no need to annoyingly change a photographic distance when a photographic range is changed.

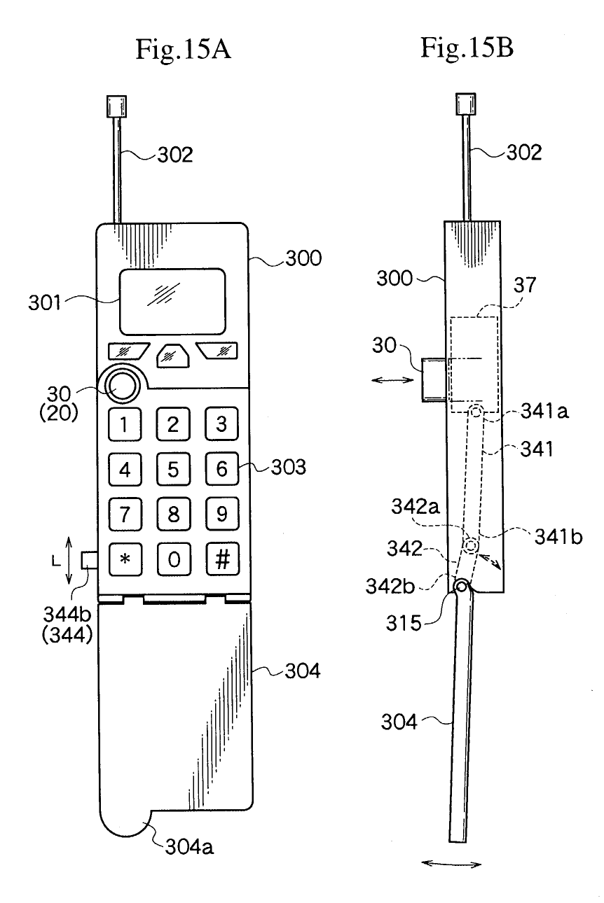

FIGS. 15A and 15B through FIGS. 19A, 19B and 19C show another embodiment of the portable information terminal device (herein, portable telephone) according to the present invention. Since the camera unit 20 (optical unit 30) is the same as that shown in FIG. 2 through FIG. 4 mentioned above, a description thereof is omitted here. As shown in FIGS. 15A and 15B, this portable telephone includes a main body 300 by which an outline is defined, a display portion (liquid crystal monitor) 301 that can display various information about transmission and reception, an extensible/contractable antenna 302, various operating buttons 303, a flipper 304 openably and closably provided for covering the operating buttons 303, etc., and the aforementioned camera unit 20 for photographing a to-be-photographed object.

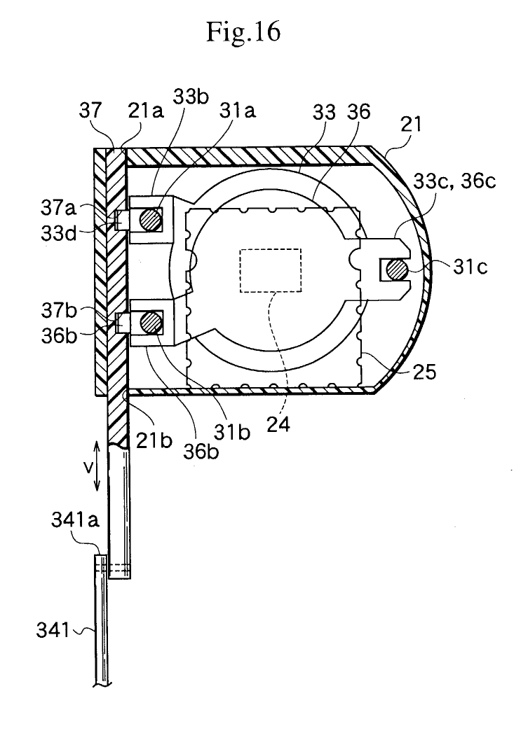

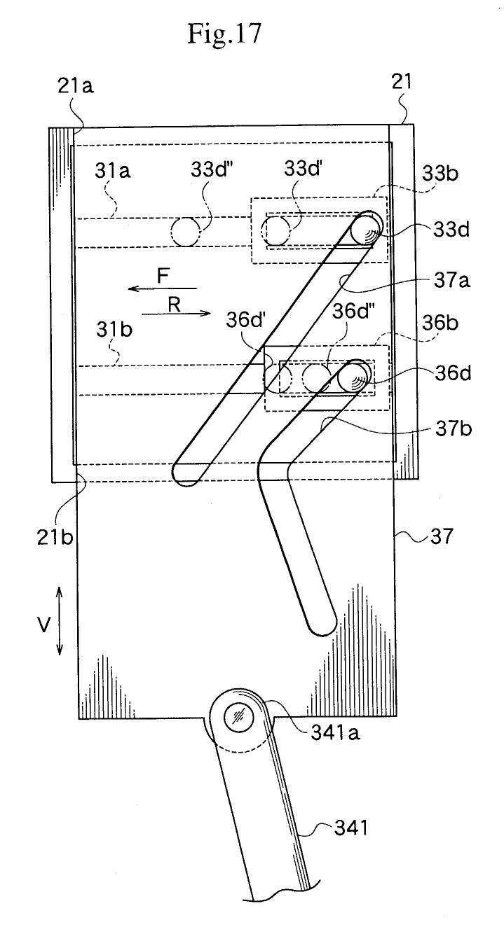

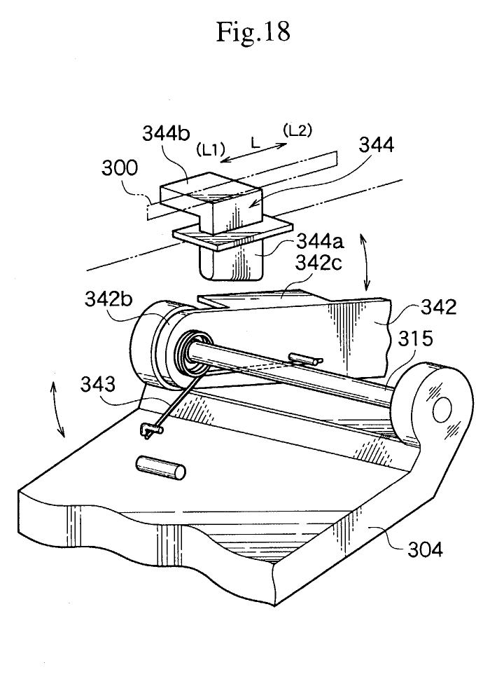

As shown in FIG. 16 and FIG. 17, the cam plate 37 is a rectangular flat plate, and is reciprocatively guided in the upward/downward direction (direction “V”) by upper and lower rectangular holes 21a and 21b formed in the case 21. The cam plate 37 has, in its side face, a first cam groove 37a formed linearly and slantingly and a second cam groove 37b shaped substantially like “<”. An end 341a of a first connection member 341 is swingably connected to the lower end of the cam plate 37 as shown in FIG. 16 and FIG. 17. The other end 341b of the first connection member 341 is rotatably connected to an end 342a of a second connection member 342 as shown in FIG. 15B. The other end 342b of the second connection member 342 is swingably connected to a supporting shaft 315 of the flipper 304 as shown in FIG. 15B and FIG. 18.

As shown in FIG. 18, an interlocking spring 343 is disposed between the second connection member 342 and the flipper 304. The interlocking spring 343 is set to exert an urging force when the second connection member 342 and the flipper 304 come off from a predetermined angle.

In greater detail, when the space between the flipper 304 and the second connection member 342 becomes smaller than a predetermined angle, an urging force is exerted so as to separate both of these, and, on the other hand, when the flipper 304 and the second connection member 342 move apart from each other, and the space therebetween becomes greater than the predetermined angle, an urging force is exerted so as to approach each other.

Therefore, when the flipper 304 is closed, the second connection member 342 is urged clockwise in FIG. 15B so as to press the first connection member 341 downward. On the other hand, when the flipper 304 is opened, the second connection member 342 is urged counterclockwise in FIG. 15B so as to press the first connection member 341 upward. The first connection member 341, the second connection member 342, the interlocking spring 343, etc., compose an interlocking mechanism for situating the optical unit 30 at the photographic position and at the housed position in an interlocked manner with the opening/closing of the flipper 304.

As shown in FIG. 18, the second connection member 342 has a flat part 342c in the vicinity of the other end 342b thereof. On the other hand, the main body 300 has a restriction member 344 supported reciprocatively in the direction of “L” as shown in FIG. 15A and FIG. 18. The restriction member 344 is made up of a cam portion 344a that is engaged/disengaged with/from the flat part 342c and exerts a cam action, and an operating portion 344b that appears on the exterior of the main body 300 and is manually operated.

That is, in FIG. 18, when the restriction member 344 is situated at the movable end in the direction of “L1”, the second connection member 342 is smallest at the swing angle, and, when the restriction member 344 is situated at the movable end in the direction of “L2”, the second connection member 342 is greatest at the swing angle.

The restriction member 344 can restrict a swing of the second connection member 342 from the moment when the optical unit 30 reaches the photographic position of the telephotographic-side end by opening the flipper 304. Thereafter, until the optical unit 30 reaches the photographic position of the wide-angle-side end, the restriction member 344 can continuously restrict a swing angle of the second connection member 342 in accordance with its position.

In greater detail, the optical unit 30 is first caused to protrude to the photographic position of the telephotographic-side end by opening the flipper 304, and the swing position of the second connection member 342 is then adjusted by adjusting the restriction member 344. Therefore, the variable-power operation of the optical unit 30 can be performed in the photographic range from the telephotographic-side end to the wide-angle-side end.

A switch (not shown) is provided for detecting the contact between the restriction member 344 and the flat part 342c of the second connection member 342. A power source from which electric power is supplied to the CCD 24 is turned on/off by this switch. In detail, the flipper 304 in the closed state is opened, and the flat part 342c of the second connection member 342 is brought into contact with the cam portion 344a. Simultaneously with the contact, the switch is activated, and electric power begins to be supplied to the CCD 24.

Therefore, when the restriction member 344 is at the position of the end in the direction of “L1” in FIG. 18, the flipper 304 is opened, and, at the moment when the optical unit 30 protrudes to the position of the telephotographic-side end, the CCD 24 is turned on, and a photographable state is reached. On the other hand, when the restriction member 344 is at the position of the end in the direction of “L2” in FIG. 18, the flipper 304 is opened, and, at the moment when the optical unit 30 protrudes to the position of the wide-angle-side end, the CCD 24 is turned on, and a photographable state is reached. When the restriction member 344 is at a halfway position, the CCD 24 is turned on, and a photographable state is reached at the moment when the optical unit 30 is at a halfway variable-power position.

Since the switch is activated, and photography is performed through the CCD 24 merely by opening the flipper 304 in this way, instantaneous photography can be performed, and a time lag that is spent until the photography is performed can be reduced.

As shown in FIGS. 15A and 15B, the flipper 304 is rotatable around the supporting shaft 315, and has a semicircular part 304a with which the optical unit 30, in addition to the operating buttons 303, is covered in the closed state. Therefore, in the closing state, the optical unit 30 is covered with the semicircular part 304a, and therefore outside light can be prevented from entering the CCD 24, and dust, flaws, etc., can be prevented from adhering to or occurring in the concave lens 32, etc.

As described above, since a part of the flipper 304 is combinedly used as a member for covering and protecting the optical unit 30 without providing an independent member, the number of constituent parts can be reduced, and cost reductions can be achieved. Although the flipper 304 is shaped to cover the range from the operating buttons 303 to the optical unit 30 in this embodiment, the flipper 304 can be, of course, shaped to cover the display portion 301 in addition to the operating buttons 303 and the optical unit 30.

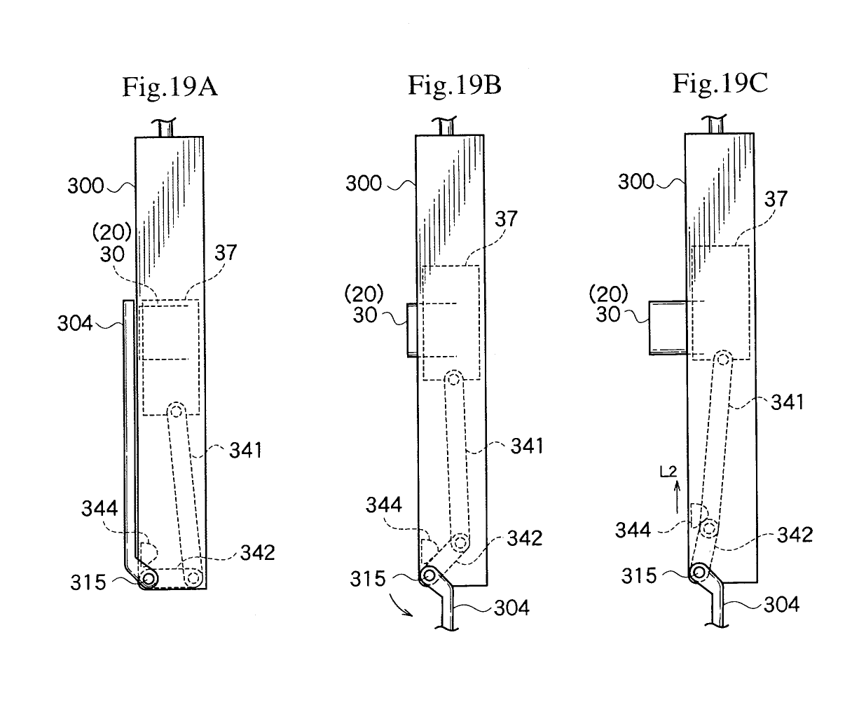

Next, a description will be given of the operation of the portable telephone according to this embodiment with reference to FIG. 2, FIG. 3, FIG. 4, FIG. 17, FIGS. 19A, 19B and 19C.

First, in a non-operating state, the flipper 304 is closed as shown in FIG. 19A, and the optical unit 30 is at the dormant position to which the optical unit 30 has receded from the surface of the main body 300 as shown in FIG. 2. At this time, the cam plate 37 is situated at the movable end downward in the V direction as shown in FIG. 17. The optical unit 30 is covered with the flipper 304.

At this time, the restriction member 344 is situated at the movable end in the direction of “L1”. As shown in FIG. 19B, when the operator opens the flipper 304 in this state, the second connection member 342 and the first connection member 341 are moved in an interlocked manner with its movement, and the cam plate 37 is moved upward in FIG. 17. The second connection member 342 is then brought into contact with the restriction member 344 and stops, and the cam plate 37 stops.

Therefore, the pin 33d of the first lens frame 33 is moved forward (direction of arrow “F”) by the cam action of the first cam groove 37a, and arrives at the position of the pin 33d′ in FIG. 17. On the other hand, the pin 36d of the second lens frame 36 is moved forward (direction of arrow “F”) by the cam action of the second cam groove 37b, and arrives at the position of the pin 36d′ in FIG. 17.

At this moment, the optical unit 30 (the first lens frame 33) slightly emerges from the surface of the main body 300, and is situated at the photographic position of the telephotographic-side end as shown in FIG. 3 and FIG. 19B. Simultaneously, the switch is activated, and electric power begins to be supplied to the CCD 24, whereby photography can be immediately performed.

When the restriction member 344 is moved in the direction of “L2” from the state of being situated at the photographic position of the telephotographic-side end, the second connection member 342 further swings so as to press the first connection member 341 upward, and the cam plate 37 is further moved upward in FIG. 17. When the restriction member 344 is moved to the movable end in the direction of “L2”, the cam plate 37 is moved to the uppermost end.

As a result, the pin 33d of the first lens frame 33 is moved forward (direction of arrow “F”) by the cam action of the first cam groove 37a, and arrives at the position of the pin 33d″ in FIG. 17. On the other hand, the pin 36d of the second lens frame 36 is moved rearward (direction of arrow “R”) by the cam action of the second cam groove 37b, and arrives at the position of the pin 36d″ in FIG. 17. At this moment, the optical unit 30 (the first lens frame 33) emerges from the surface of the main body 300 to the furthest protrusion, and is situated at the photographic position of the wide-angle-side end as shown in FIG. 4 and FIG. 19C.

On the other hand, when the restriction member 344 is moved in the direction of “L1” opposite to that of “L2” from this state, the second connection member 342 is pushed back, and the optical unit 30 begins to recede, and reaches the photographic position of the telephotographic-side end. When the flipper 304 is closed in a state in which the restriction member 344 is situated at any position, the second connection member 342 and the first connection member 341 begin to return to the original position, and, when the second connection member 342 is disengaged from the restriction member 344, the electric-power supply to the CCD 24 is cut off, and the optical unit 30 also returns to the retracted, dormant position.

As described above, the optical unit 30 is situated at the photographic position merely by permitting the operator to open the flipper 304, and it becomes possible to perform photography through the CCD 24. Additionally, it is possible to continuously perform variable-power operation from the photographic position of the telephotographic-side end to the photographic position of the wide-angle-side end merely by operating the restriction member 344.

Therefore, an annoying preparatory operation does not need to be performed for photography, and a photographable state can be immediately reached merely by opening the flipper 304. Therefore, a time lag that is spent until the photographable state is reached can be reduced as much as possible, and a portable telephone excellent in convenience can be achieved. Additionally, since the switching between the telephotography and the wide-angle photography can be continuously performed merely by appropriately adjusting the position of the restriction member 344, there is no need to annoyingly change a photographic distance when a photographic range is changed.

In the aforementioned embodiment, a variable-power optical system has been employed as the optical unit 30. However, even if a monofocal optical unit is employed, a smooth shift to a photographing motion can be accomplished by situating the optical unit 30 at a photographic position so as to be interlocked with the flipper 304 and by interlocking the ON/OFF of the CCD 24 therewith. Additionally, in the aforementioned embodiment, the cam action of the cam plate 37 has been employed as a driving mechanism by which the power of the optical unit 30 becomes variable. However, without being limited to this, other mechanisms can be employed.

Still additionally, in the aforementioned embodiment, a description has been given of the structure in which the cam plate 37 is driven in an interlocked manner with the opening/closing of the flipper 304. However, the cam plate 37 may be electrically driven by connecting a pinion to be engaged with a rack formed on the cam plate 37 to an electric actuator, such as a motor, and by turning the switch on/off in an interlocked manner with the opening/closing of the flipper 304.

Still additionally, in the aforementioned embodiment, the portable telephone has been shown as a portable information terminal device to which the present invention is applied. However, without being limited to this, the present invention can be applied to a portable personal computer that has the same structure as the flipper.

As described above, according to this portable information terminal device, the optical unit 30 can be situated at the photographic position and the housed position only by opening and closing the flipper 304. Additionally, since the optical unit 30 is formed to serve as a variable-power optical system, variable-power photography from telephotography to wide-angle photography can be performed without changing the photographic position.

Additionally, since the connection members 341, 342, the interlocking spring 343, etc., compose the interlocking mechanism, a structural simplification, a size reduction, a weight reduction, etc., can be achieved.

Still additionally, since the restriction member 344 is provided, the optical unit 30 can be stopped at a predetermined photographic position in spite of the fact that the flipper 304 is completely opened, and, by making a positional adjustment, the variable-power operation of the optical unit can be performed in the photographic range from the telephotographic-side end to the wide-angle-side end.

Still additionally, since electric power begins to be supplied to the CCD 24 when the optical unit 30 is situated at the photographic position, instantaneous photography can be performed only by opening the flipper 304, and a time lag spent until photography is performed can be reduced.

Still additionally, since the optical unit 30 is covered with the flipper 304, the CCD 24 can be shaded from light, and fingerprints, dust, etc., can be, of course, prevented from adhering to the lens surface of the optical unit 30, and the number of constituent parts can be reduced, and cost reductions can be achieved by combinedly using the flipper 304.

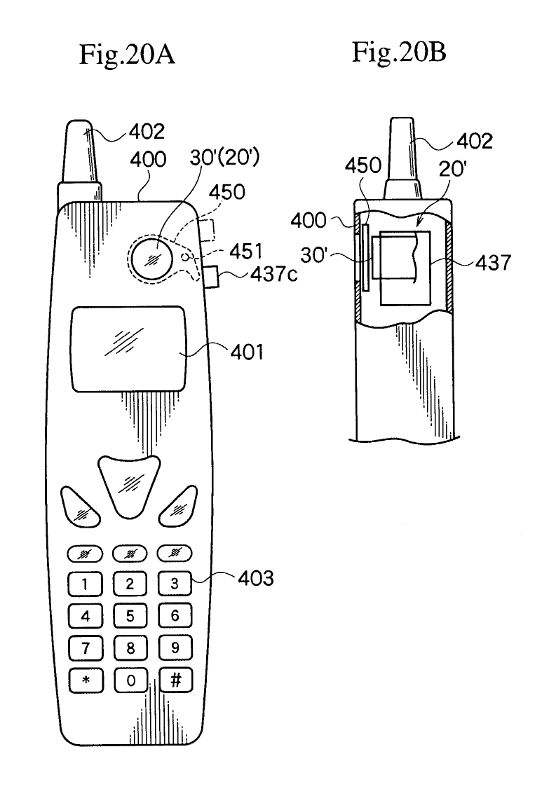

FIGS. 20A, 20B through FIG. 23 show another embodiment of the portable information terminal device (herein, portable telephone) according to the present invention. Except for the fact that the cam plate and a case that compose a driving mechanism of a camera unit 20′ (optical unit 30′) are different from those of the aforementioned camera unit 20 (optical unit 30), the camera unit 20′ (optical unit 30′) is the same as the camera unit 20 (optical unit 30), and the camera unit 20′ (optical unit 30′) has the same structure as in FIG. 2 through FIG. 4. Therefore, a description thereof is omitted.

As shown in FIGS. 20A and 20B, this portable telephone includes a main body 400 by which an outline is defined, a display portion (liquid crystal monitor) 401 that is disposed on the surface of the main body 400 and that can display various information about transmission and reception, an antenna 402, various operating buttons 403, the aforementioned camera unit 20′ for photographing a to-be-photographed object, an operating portion 437c for manually making a variable-power adjustment of the camera unit 20′, and a shielding member (shielding plate) 450 disposed inside the main body 400.

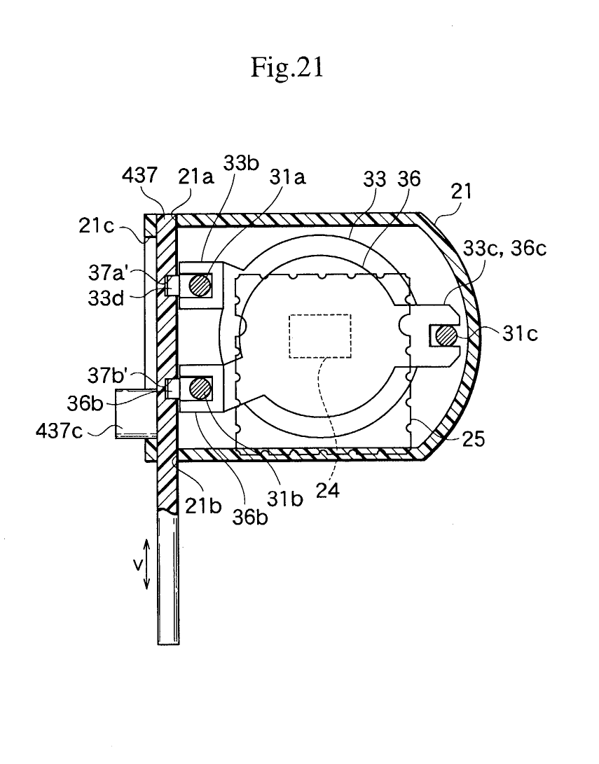

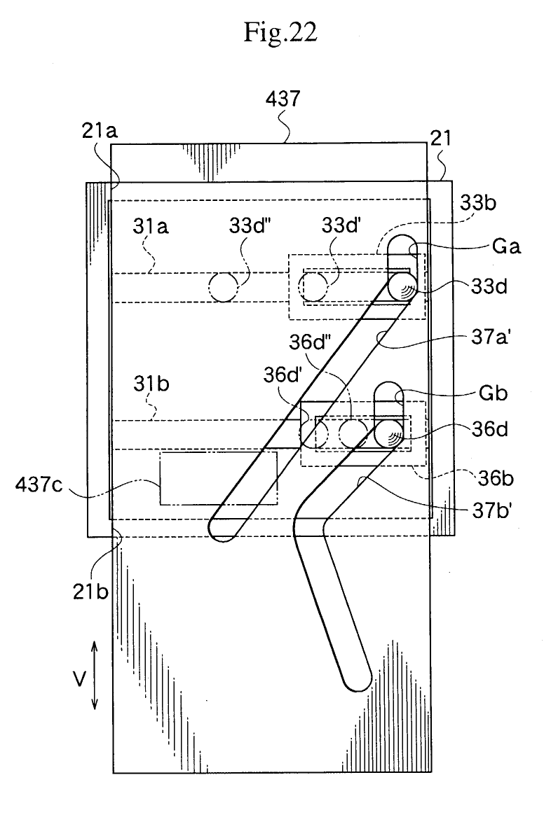

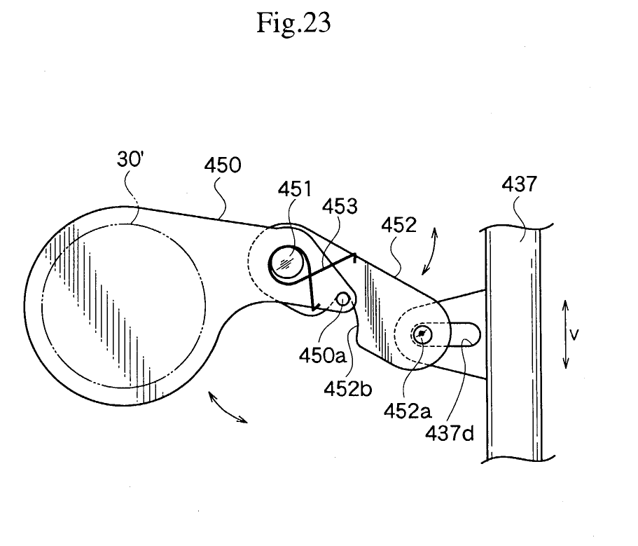

As shown in FIG. 21 and FIG. 22, a cam plate 437 has the operating portion 437c in its side face, and, as shown in FIG. 23, a long hole 437d connected to a part of an interlocking mechanism. In addition, as shown in FIG. 22, idle spaces Ga and Gb that linearly extend by a predetermined distance in the V direction are formed at the upper right part of the first cam groove 37a′ and at the upper right part of the second cam groove 37b′, respectively. That is, only the idle spaces Ga and Gb, which do not have a cam action, are added to the first cam groove 37a and the second cam groove 37b. As shown in FIG. 21, the case 21 has an opening 21c through which the operating portion 437c protrudes and by which the moving range thereof is restricted.

Accordingly, when the operator grips the operating portion 437c and moves it upward in the direction of “V”, the first lens frame 33 of the optical unit 30′ begins to move forward and emerges from the main body 400 forward as shown in FIG. 3 and FIG. 4 through a predetermined idle process (during this time, an operation is performed to retract the shielding plate 450 and expose the optical unit 30). On the other hand, when the operator moves it downward in the direction of “V”, the first lens frame 33 recedes and is housed in the main body 400. After the housed operation is completed, the operating portion 437c is brought into contact with the lower end of the opening 21c, and is stopped through a predetermined idle process (during this time, the shielding plate 450 shields the optical unit 30′).

The cam plate 437 has a part (not shown) that is engaged/disengaged with/from a switch (not shown) for turning a power source, which supplies electric power to the CCD 24, on/off. When this part reaches a photographic position (i.e., photographic position at the telephotographic-side end shown in FIG. 3) shifted by a predetermined amount upward from the position shown in FIG. 21, the part is engaged with the switch so as to turn the switch on, and therefore electric power begins to be supplied to the CCD 24. On the other hand, when the cam plate 437 is moved in the opposite direction, the switch is turned off, and therefore electric power ceases to be supplied to the CCD 24.

As shown in FIG. 20A and FIG. 23, the shielding plate 450 used as a shielding member is supported swingably around a supporting shaft (predetermined shaft) 451 fixed to the main body 400, and has a pin 450a on the opposite side to the side facing the optical unit 30′.

A swinging arm 452 is supported swingably around the supporting shaft 451. As shown in FIG. 23, in the swinging arm 452, a pin 452a disposed at its end is connected to a long hole 437d of the cam plate 437, and a notched part 452b formed substantially in the middle is engaged/disengaged with/from the pin 450a.

As shown in FIG. 23, an interlocking spring 453 is disposed between the shielding plate 450 and the swinging arm 452. The interlocking spring 453 interlocks the motion of the swinging arm 452 with the shielding plate 450, and exerts an urging force in the direction in which the optical unit 30 is exposed (so as to rotate the shielding plate 450 counterclockwise in FIG. 23 with respect to the swinging arm 452).

Therefore, when the cam plate 437 is moved upward from the state in which the shielding plate 450 shields the optical unit 30′ as shown in FIG. 23, the swinging arm 452 rotates counterclockwise, and, by the urging force of the interlocking spring 453, the shielding plate 450 is caused to recede from the optical unit 30′ so as to expose it, and is brought into contact with a stopper (not shown), and is stopped. When the cam plate 437 is further moved upward, the notched part 452b is disengaged from the pin 450a while the shielding plate 450 maintains its state, and the optical unit 30′ begins to protrude, and the variable-power operation from the telephotographic side to the wide angle side is performed.

On the other hand, when the cam plate 437 is moved in the opposite direction, the swinging arm 452 begins to be rotated clockwise, and the optical unit 30′ begins to recede into the dormant position. After it has completely receded into the dormant position, the notched part 452b is engaged with the pin 450a, and the shielding plate 450 is rotated together clockwise. When the cam plate 437 is stopped, the shielding plate 450 reaches a state in which the optical unit 30′ is completely shielded.

The notched part 452b and the pin 450a compose a restraining mechanism for restraining the shielding plate 450 to move together with the swinging arm 452 at a predetermined timing (time point when the optical unit 30 has completely receded) during the shielding motion. The swinging arm 452, the interlocking spring 453, the notched part 452b, and the pin 450a compose an interlocking mechanism for allowing the shielding plate 450 to perform a shielding motion and an exposing motion in an interlocked manner with the operation of the driving mechanism by which the optical unit 30′ is driven.

Next, a description will be given of the operation of the portable telephone according to this embodiment.

First, in a non-operating state, the operating portion 437c is situated at a lower end as shown in FIGS. 20A and 20B, and the optical unit 30′ is at the dormant position to which it has receded from the surface of the main body 400, and the shielding plate 450 shields the front surface of the optical unit 30′ as shown in FIG. 2, and FIGS. 20A and 20B. At this time, the cam plate 437 is situated at the movable end downward in the V direction.

When the operator moves the operating portion 437c upward in this state, the cam plate 437 is moved upward. Accordingly, the pin 33d of the first lens frame 33 and the pin 36d of the second lens frame 36 are moved downward in the idle spaces Ga and Gb and reach the positions shown by the solid lines, respectively. On the other hand, during this idle movement, the swinging arm 452 rotates counterclockwise, and the shielding plate 450 also rotates counterclockwise so as to recede from the optical unit 30′ and so as to completely expose it.

Subsequently, when the operator moves the operating portion 437c upward in the V direction, the cam plate 437 is moved upward. The pin 33d of the first lens frame 33 and the pin 36d of the second lens frame 36 are moved forward (direction of arrow “F”) by the cam action of the first cam groove 37a′ and the cam action of the second cam groove 37b′, and arrive at the position of the pin 33d′ and the position of the pin 36d′, respectively.

At this moment, the optical unit 30′ slightly emerges from the surface of the main body 400, and is situated at the photographic position of the telephotographic-side end as shown in FIG. 3. Simultaneously, a part of the cam plate 437 is engaged with the switch so as to turn it on, and electric power begins to be supplied to the CCD 24. Therefore, photography can be immediately performed.

When the operator further moves the operating portion 437c upward from the state of being situated at the photographic position of the telephotographic-side end, the optical unit 30′ protrudes from the main body 400 to the furthest protrusion and is situated at the photographic position of the wide-angle-side end as shown in FIG. 4 by the action of the first cam groove 37a′ of the cam plate 437 and by the action of the second cam groove 37b′ thereof in the same way as in the aforementioned embodiment.

On the other hand, when the operator moves the operating portion 437c in the opposite direction (downward), the optical unit 30′ is moved from the photographic position of the wide-angle-side end to the photographic position of the telephotographic-side end. At this moment, a part of the cam plate 437 is activated to turn the switch off, and electric power ceases to be supplied to the CCD 24. Thereafter, the optical unit 30′ is completely retracted from the surface of the main body 400, and reaches the dormant position as shown in FIG. 2.

Thereafter, when the operating portion 437c is further moved downward, the notched part 452b of the swinging arm 452 is engaged with the pin 450a of the shielding plate 450 so as to rotate the shielding plate 450 together clockwise, and the shielding plate 450 reaches a state of completely shielding the front surface of the optical unit 30′.

Since the shielding plate 450 shields or exposes the optical unit 30′ in an interlocked manner with the variable-power operation of the optical unit 30′ by the cam plate 437 in this way, both of these are prevented from interfering with each other, and functional reliability is secured without allowing the motion timing of the shielding plate 450 to misalign when the optical unit 30′ emerges or recedes. Additionally, since the variable-power operation of the optical unit 30′ is performed, and the shielding plate 450 is operated merely by allowing the operator to move the operating portion 437c, there is no need to perform a plurality of annoying operational steps, and a portable telephone excellent in convenience can be achieved.

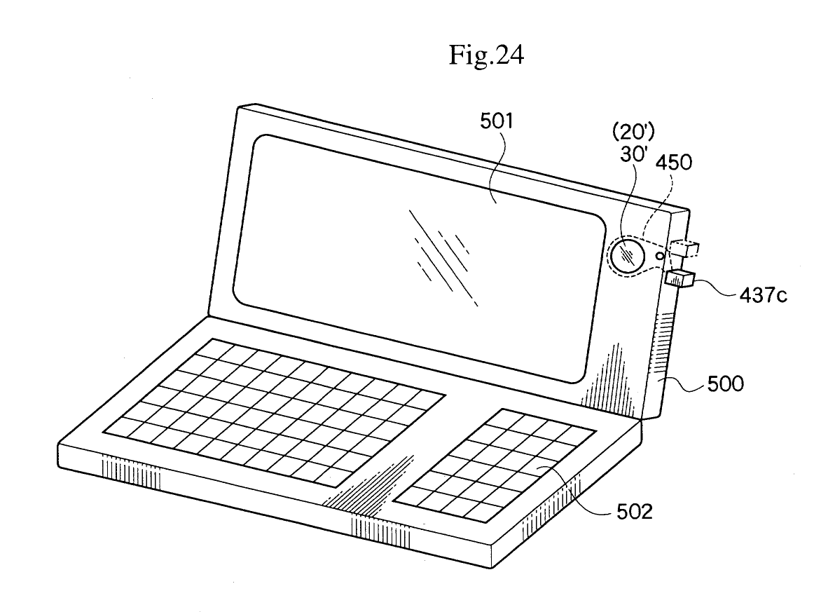

FIG. 24 shows another embodiment of the portable information terminal device (herein, portable personal computer) according to the present invention. As shown in FIG. 24, this portable personal computer includes a main body 500 by which an outline is defined, a display portion (liquid crystal monitor) 501 that is disposed on the surface of the main body 500 and that can display various information, various operating buttons 502, the aforementioned camera unit 20′ (optical unit 30′) for photographing a to-be-photographed object, the aforementioned operating portion 437c for manually performing a variable-power adjustment of the camera unit 20′, and the aforementioned shielding plate 450 for shielding the optical unit 30′. Since the camera unit 20′ (optical unit 30′), the shielding plate 450, the interlocking mechanism, etc., are the same as in the aforementioned embodiment, a description of these is omitted here.

Also, in this portable personal computer, the variable-power operation of the optical unit 30′ and the shielding/exposing operation of the shielding plate 450 are performed only by operating the operating portion 437c, and are infallibly performed at a predetermined timing without interfering with each other.

In the aforementioned embodiment, the shielding plate 450 that can swing has been employed as a shielding member. However, this may be a member that can linearly reciprocate. Additionally, the swinging arm 452, the interlocking spring 453, etc., have been employed as elements of the interlocking mechanism that interlocks the shielding member with the driving mechanism. However, the present invention is not limited to this. Other interlocking mechanisms may be employed if actions are exerted such that the shielding member exposes the optical unit 30′ before the optical unit 30′ begins to protrude from the retracted, dormant position, and such that the shielding member shields the optical unit 30′ after the optical unit 30′ recedes into the dormant position. Additionally, in the aforementioned embodiment, the hand-operated driving mechanism has been shown as a driving mechanism of the optical unit 30′. However, the present invention is not limited to this. As long as the interlocking relationship with the shielding member is secured, an electrically-operated driving mechanism that uses an electric actuator, for example, may be employed.

As described above, according to these portable information terminal devices, the shielding member 450 is provided which can shield the front surface of the optical unit 30′ while interlocking with the driving mechanism of the optical unit 30′. Therefore, the optical unit 30′ can be shielded, and fingerprints, dust, etc., can be, of course, prevented from adhering to the optical unit 30′. Additionally, the optical unit 30′ and the shielding member 450 can be prevented from interfering with each other without allowing the timing of the shielding/exposing operation of the shielding member 450 to go off with respect to the variable-power operation of the optical unit 30′, and functional reliability is secured. Still additionally, since the swinging arm 452, the interlocking spring 453, etc., are used as elements of the interlocking mechanism by which the driving mechanism and the shielding member 450 are interlocked with each other, a structural simplification, a weight reduction, a size reduction, a cost reduction, etc., can be achieved.

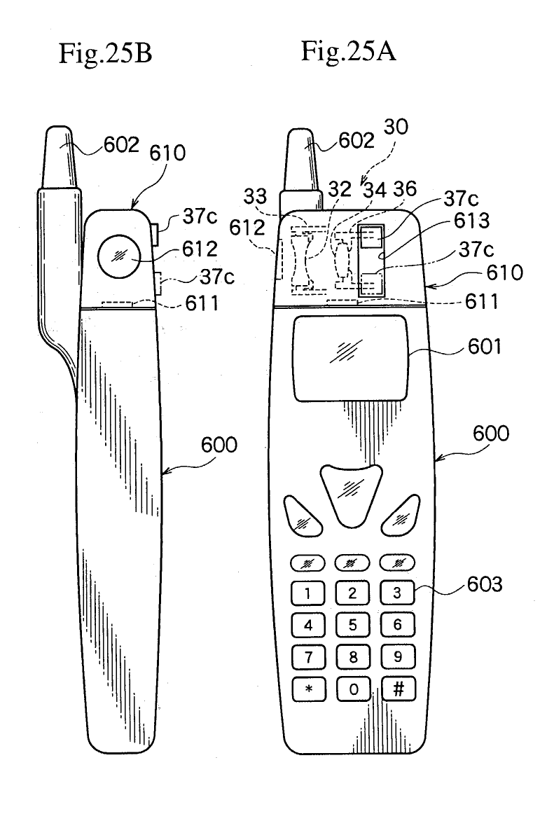

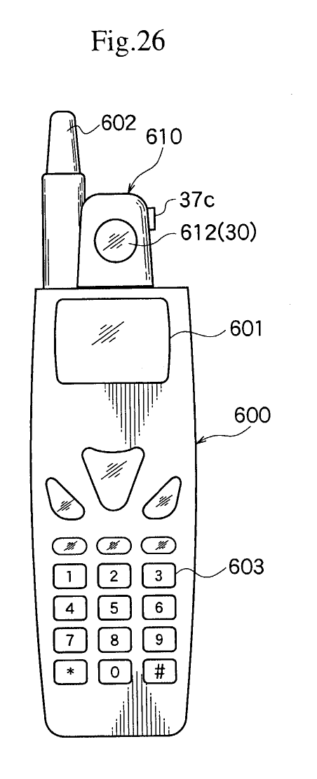

FIGS. 25A and 25B, and FIG. 26 show another embodiment of the portable information terminal device (herein, portable telephone) according to the present invention. This portable telephone includes a main body 600 by which an outline is defined, a display portion (liquid crystal monitor) 601 that is disposed on the surface of the main body 600 and that can display various information about transmission and reception, an antenna 602, various operating buttons 603, a camera unit 610 for photographing a to-be-photographed object, and an information-signal processing portion (not shown) disposed inside the main body 600 for performing various information-signal processing.

The camera unit 610 contains the optical unit 30 shown in FIG. 2 through FIG. 5, and defines a part of the outline of the main body 600. In addition, the camera unit 610 is formed independently of the main body 600, and is modularized, and is connected to a connection part 611 so that it can rotate (oscillate) within an angle of roughly 90 degrees. The connection part 611 has the same structure as that shown in FIG. 8A. The optical unit 30 performs the variable-power operation while manually moving the operating portion 37c of the cam plate 37 upward and downward. Since this structure is the same as the aforementioned one, a description thereof is omitted here.

As shown in FIGS. 25A and 25B, the camera unit 610 has a transparent window 612 for photography, and an opening 613 through which the operating portion 37c protrudes. The optical unit 30 is disposed behind the inside of the transparent window 612 so that it can perform the variable-power operation. In greater detail, the optical unit 30 performs the variable-power operation inside without appearing on the exterior of the camera unit 610 even when it is moved from the dormant position shown in FIG. 2 to the photographic position of the wide-angle-side end shown in FIG. 4 through the photographic position of the telephotographic-side end shown in FIG. 3.

The operation of this portable telephone will be described. First, in a non-operating state, the camera unit 610 is rotated so as to situate the operating portion 37c forward, and is positioned along the outline of the main body 600 as shown in FIGS. 25A and 25B.

Thereafter, when photography is performed through the camera unit 610, the camera unit 610 is rotated by roughly 90 degrees so that the operating portion 37c is situated on the right face as shown in FIG. 26. When the operating portion 37c is moved upward in order to move the optical unit 30 stopping at the dormant position to the photographic position in this state, the CCD 24 is turned on at the photographic position of the telephotographic-side end as described above, and it becomes possible to perform photography from the telephotographic side to the wide-angle side.

On the other hand, when the operating portion 37c is moved downward to the lower edge in order to end the photography, the CCD 24 is turned off at the photographic position of the telephotographic-side end as mentioned above, and, subsequently, the optical unit 30 returns to the dormant position. Thereafter, the camera unit 610 is rotated in the opposite direction by roughly 90 degrees so as to return to the original position shown in FIGS. 25A and 25B. Thus, the optical unit 30 never appears on the exterior, and always stays inside the camera unit 610 even when photographic operation is performed. Therefore, the optical unit 30 can be prevented from colliding, and flaws, fingerprints, dust, etc., can be prevented from occurring in or adhering to the lens surface.

In the aforementioned embodiment, an example has been shown in which the variable-power operation for photography is performed when the transparent window 612 is situated forward. However, even if it is directed to a halfway rotational-angle position, photography can be performed by the variable-power operation of the optical unit 30.

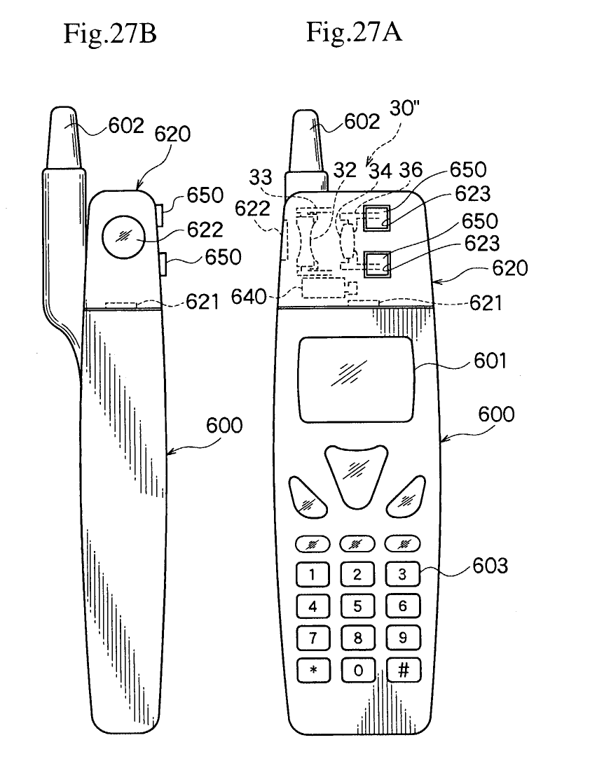

FIGS. 27A and 27B through FIG. 30 show another embodiment of the portable information terminal device (herein, portable telephone) according to the present invention. In this embodiment, the optical unit 30 shown in FIG. 25A through FIG. 26 is changed from the hand-operated one to the motor-driven one.

As shown in FIGS. 27A and 27B, this portable telephone includes a main body 600 by which an outline is defined, a display portion (liquid crystal monitor) 601, an antenna 602, operating buttons 603, a camera unit 620 for photographing a to-be-photographed object, and an information-signal processing portion (not shown) disposed inside the main body 600 for performing various information-signal processing.

The camera unit 620 contains an optical unit 30″, and defines a part of the outline of the main body 600. In addition, the camera unit 620 is formed independently of the main body 600, and is modularized, and is connected to a connection part 621 so that it can rotate (oscillate) within an angle of roughly 90 degrees. The connection part 621 has the same structure as that shown in FIG. 8A. Except for the fact that the cam plate 637 is driven by a motor 640, the optical unit 30″ has the same structure as the optical unit 30 shown in FIG. 2 through FIG. 5. Therefore, the same reference character is given to the same constituent element, and a description thereof is omitted.

As shown in FIGS. 27A and 27B, the camera unit 620 has a transparent window 622 for photography, and an opening 623 through which a switch button 650 protrudes. The optical unit 30″ is disposed behind the inside of the transparent window 622 so that the optical unit 30″ can perform the variable-power operation. That is, the optical unit 30″ performs the variable-power operation inside without appearing on the exterior of the camera unit 620 in the same way as in the aforementioned embodiment.

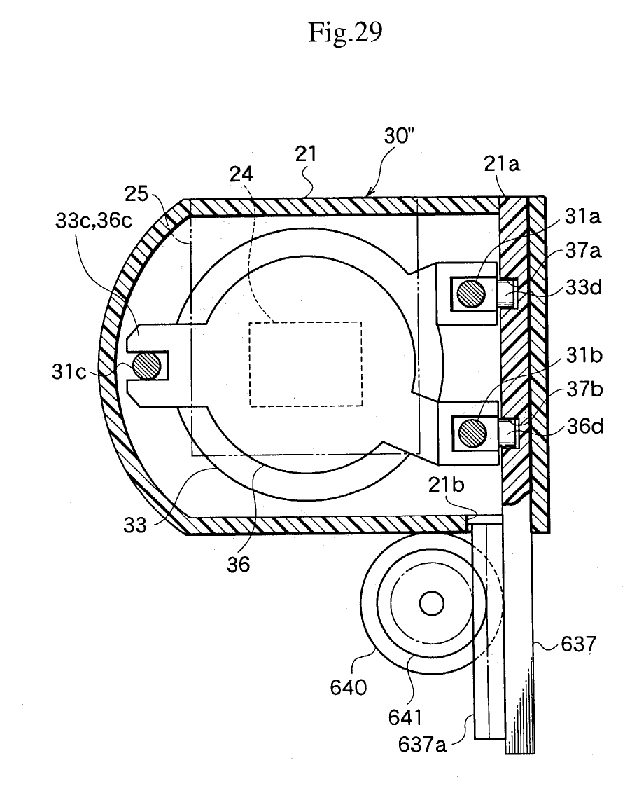

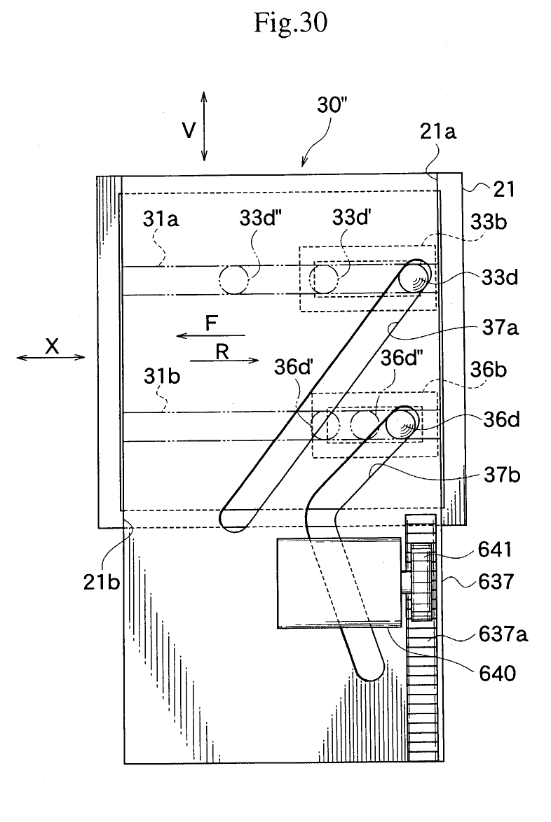

In the optical unit 30″, the cam plate 637 has a rack 637a, in addition to the first cam groove 37a and the second cam groove 37b, as shown in FIG. 29 and FIG. 30. The motor 640 is fixed to the case 21, and a pinion 641 is engaged with the rack 637a of the cam plate 637.

Therefore, when the motor 640 rotates in a direction, the cam plate 637 is moved upward in the V direction, and the first cam groove 37a and the second cam groove 37b exert a cam action to the first lens frame 33 and the second lens frame 36, respectively, so as to perform the variable-power operation from the telephotographic side to the wide-angle side. On the other hand, when the motor 640 rotates in the opposite direction, the cam plate 637 is moved downward in the V direction, and the first lens frame 33 and the second lens frame 36 are caused to return to the dormant position (retracted position). The motor 640 rotates in one direction when the one switch button 650 protruding through the opening 623 is pushed, and the motor 640 rotates in the opposite direction when the other switch button 650 is pushed.

The operation of this portable telephone will be described. First, in a non-operating state, the camera unit 620 is rotated so as to situate the switch button 650 forward, and is positioned along the outline of the main body 600 as shown in FIGS. 27A and 27B.

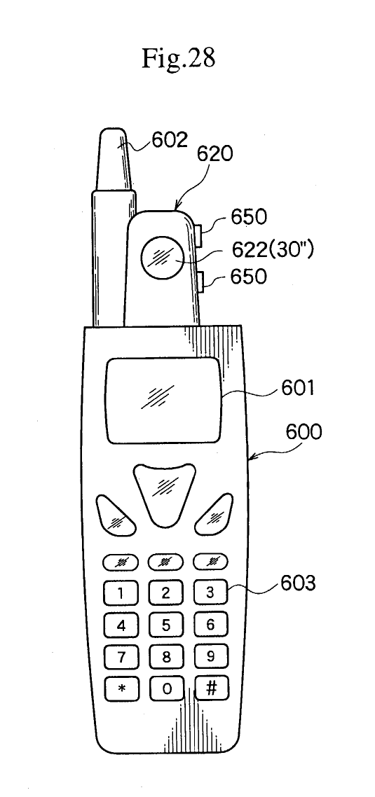

Thereafter, when photography is performed through the camera unit 620, the camera unit 620 is rotated by roughly 90 degrees so that the switch button 650 is situated at the right side face as shown in FIG. 28. When the one switch button 650 is pushed to rotate the motor 640 in one direction in order to move the optical unit 30″ stopping at the dormant position to the photographic position in this state, the CCD 24 is turned on at the photographic position of the telephotographic-side end as described above, and, thereafter, the motor 640 is appropriately stopped. Therefore, it becomes possible to perform photography from the telephotographic side to the wide-angle side.

On the other hand, in order to end the photography, the other switch button 650 is pushed, so that the motor 640 rotates in the opposite direction. Therefore, the CCD 24 is turned off at the photographic position of the telephotographic-side end, and, subsequently, the optical unit 30″ returns to the dormant position. Thereafter, the camera unit 620 is rotated in the opposite direction by roughly 90 degrees so as to return to the original position shown in FIGS. 27A and 27B. Thus, the optical unit 30″ never appears on the exterior, and always stays inside the camera unit 620 even when photographic operation is performed. Therefore, the optical unit 30″ can be prevented from colliding, and flaws, fingerprints, dust, etc., can be prevented from occurring in or adhering to the lens surface.

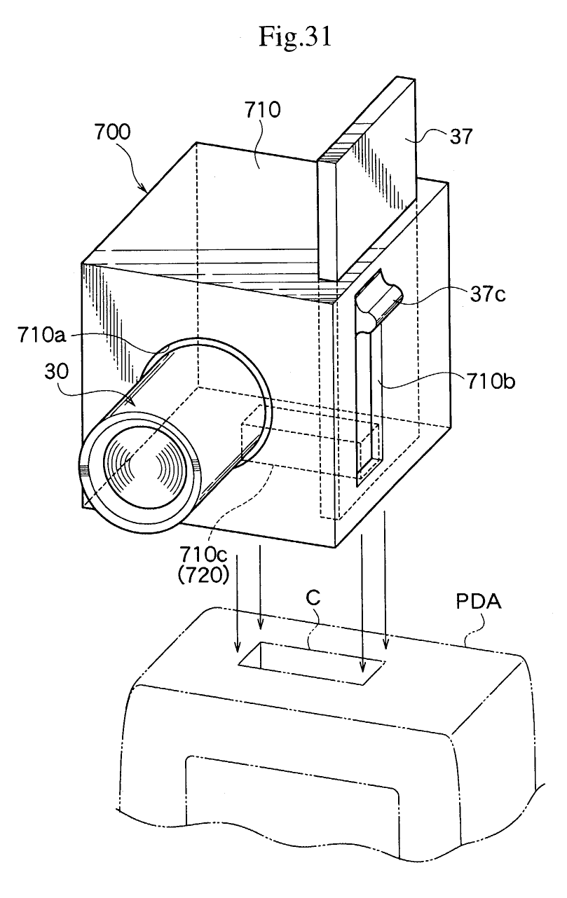

FIG. 31 through FIGS. 36A and 36B show an embodiment of a camera unit, which is attachable/detachable to/from various portable information terminal devices, according to the present invention.

As shown in FIG. 31, a camera unit 700 includes a unit case 710 by which an outline is defined, the aforementioned optical unit 30 disposed advanceably/retractably from/to the interior of the unit case 710, a driving mechanism, such as the cam plate 37, for driving the optical unit 30, a crystal filter 22, such as an infrared-ray filter or a low-pass filter, a faceplate 23, a CCD 24 serving as an image pickup element, a circuit board 25, and a connection terminal 720 connected to the circuit board 25.

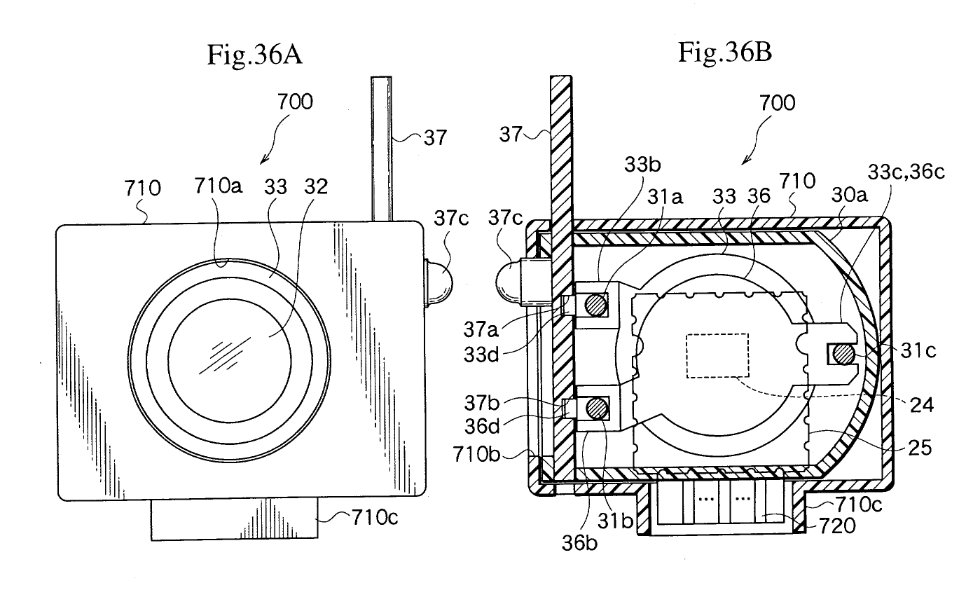

As shown in FIG. 31, and FIGS. 36A and 36B, the unit case 710 is made up of an opening 710a through which the optical unit 30 can emerge or recede, a long hole 710b for exposing the operating portion 37c of the driving mechanism to the outside, and a connector portion 710c to be connected to a connection part “C” of the portable information terminal device PDA.

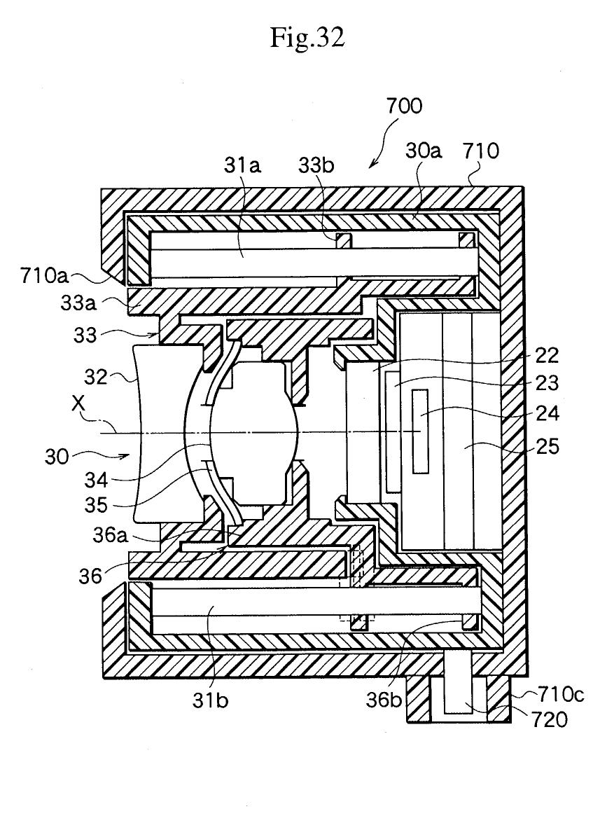

As shown in FIG. 32 through FIG. 35, the optical unit 30 is a variable-power lens optical system, which has the same structure and operation as that shown in FIG. 2 through FIG. 5. Therefore, a description of this is omitted here.

As shown in FIG. 32 and FIG. 36B, a connection terminal 720 is electrically connected to the circuit board 25. This connection terminal 720 is in a state of being exposed to the internal space of the connector portion 710c. Wires for supplying electric power to the CCD 24 and for transmitting an image signal are attached to the connection terminal 720. This may be either the contact type or the non-contact type.

Next, a description will be given of the operation of the camera unit according to this embodiment.

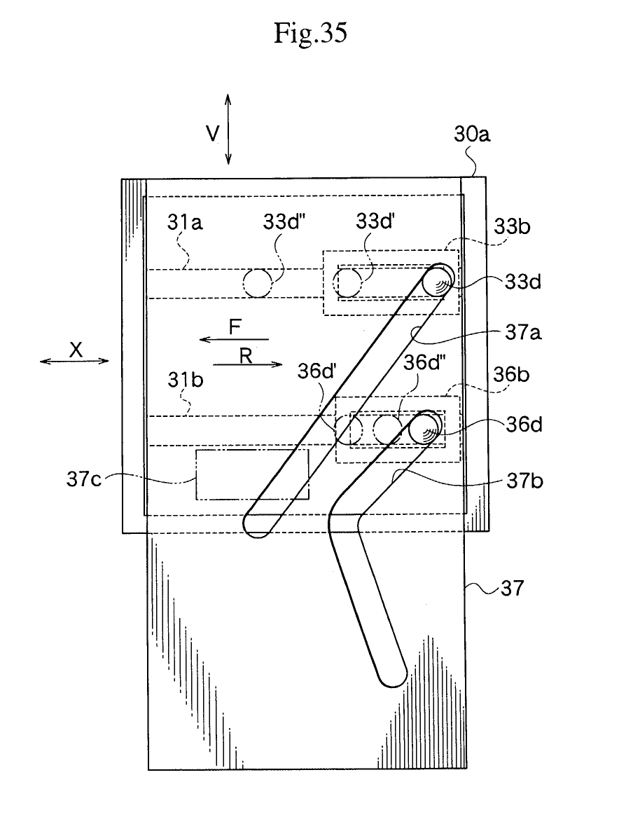

First, in a state in which the camera unit 700 has been mounted on the portable information terminal device (e.g., portable telephone) and in a non-operating state, the operating portion 37c is situated at the lower end, and the optical unit 30 is in the retracted state (dormant position) in which the optical unit 30 has receded from the opening 710a of the unit case 710 as shown in FIG. 32. At this time, the cam plate 37 is situated at the movable end downward in the V direction as shown in FIG. 35.

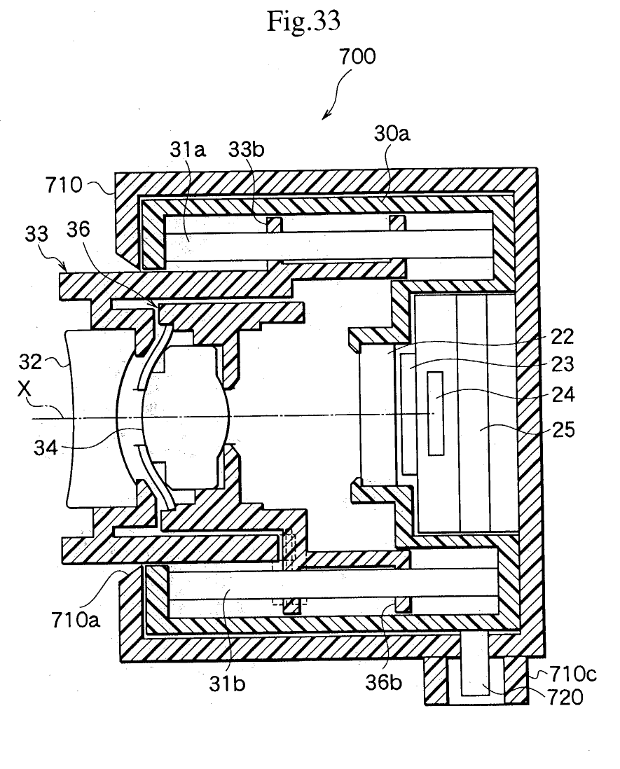

When the operator moves the operating portion 37c to a predetermined position upward in FIG. 35 in this state, the cam plate 37 is moved in an interlocked manner with its movement. Therefore, the optical unit 30 slightly emerges from the surface of the unit case 710, and is situated at the photographic position of the telephotographic-side end as shown in FIG. 33. While the operator is moving the operating portion 37c, a positioning mechanism (not shown) is actuated at the photographic position of the telephotographic-side end, and resistance to the moving operation increases, so that it becomes impossible to move the operating portion 37c with the same operating force. Therefore, at that moment, the optical unit 30 is situated at the photographic position of the telephotographic-side end.

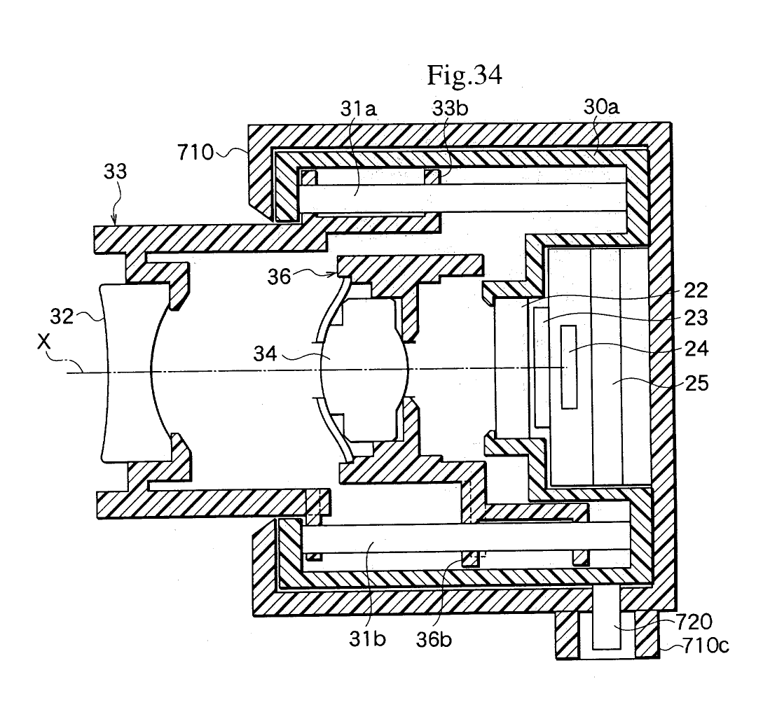

When the operator further moves the operating portion 37c with an operating force that can release the positioning force of the positioning mechanism from the photographic position of the telephotographic-side end upward, the cam plate 37 is further moved upward in an interlocked manner with its movement. As a result, the optical unit 30 further emerges from the surface of the unit case 710, and is situated at the photographic position of the wide-angle-side end as shown in FIG. 34.

On the other hand, when the operator moves the operating portion 37c in the opposite direction (downward), the optical unit 30 is moved from the photographic position of the wide-angle-side end to the photographic position of the telephotographic-side end, and reaches the retracted state at the dormant position.

Thus, only by permitting the operator to move the operating portion 37c, it is possible to move the optical unit 30 from the photographic position of the telephotographic-side end to the photographic position of the wide-angle-side end so as to continuously perform variable-power operation.

Therefore, the switching between telephotography and wide-angle photography can be continuously performed merely by, first of all, connecting the camera unit 700 to the portable information terminal device in order to begin photography, then moving the operating portion 37c, and appropriately adjusting an operational movement quantity thereof. Therefore, there is no need to annoyingly change a photographic distance when a photographic range is changed.

In the aforementioned embodiment, in the optical unit 30 to be mounted onto the attachable/detachable camera unit 700, the cam action of the cam plate 37 has been employed as a driving mechanism by which the power is varied. However, without being limited to this, other mechanisms can be employed. Additionally, the operating portion 37c that emerges from the main body 710 and is linearly moved has been employed as a hand-operated operating portion. However, instead of this, the variable-power operation of the optical unit 30 may be performed such that a rack is formed on the side face of the cam plate 37, and a pinion to be engaged with the rack is rotatably formed in the main body so as to serve as an operating portion, and the pinion (operating portion) is rotated. Additionally, the interlocking operation may be performed by use of a helicoid or others instead of the flat cam plate 37.

Still additionally, the two lenses, i.e., the concave lens 32 and the convex lens 34 have been employed as a plurality of lenses that compose the optical unit 30. However, without being limited to this, an even greater number of lenses can be used.

Still additionally, the hand-operated operating portion 37c has been provided in order to allow the optical unit 30 to perform the variable-power operation. However, instead of the hand-operated one, a motor-driven operating portion may be provided by using an electromagnetic actuator, such as a motor. In greater detail, a pinion to be engaged with a rack formed on the cam plate 37 may be rotated by an electric actuator, such as a motor.

Still additionally, the connection terminal 720 has been provided so that electric power from the power source (not shown) contained in the portable information terminal device can be supplied. However, a power source built in the camera unit 700 may be employed, and a connection terminal may be used for wiring-connection to transmit information about image-signal processing from the CCD 24.

As described above, according to this camera unit 700, since the optical unit 30 is formed to serve as a variable-power lens optical system by which variable-power photography can be performed, photography from the telephotographic side to the wide-angle side can be performed merely by adjusting the optical unit 30 without changing a photographic distance when a photographic range is to be changed. Additionally, since this unit is attachable/detachable, the unit can be applied to various portable information terminal devices. Still additionally, since the variable-power operation of the optical unit 30 can be manually performed, a cost reduction, a size reduction, a structural simplification, etc., can be achieved.

### INDUSTRIAL APPLICABILITY

As described above, the portable information terminal device and the camera unit according to the present invention can photograph an object in a wide range from the telephotographic side to the wide-angle side. Therefore, they are useful in a communications system to transmit and receive image information, etc.

What is claimed is:

1. A portable information terminal device comprising:
a display portion on which information can be displayed;
a main body on which the display portion is mounted and which defines an outline;
an image pickup element for photographing a to-be-photographed object; and
an optical unit including a plurality of lenses arranged in a direction of an optical axis and a driving mechanism for performing variable-power driving while relatively moving the plurality of lenses so that a magnification of the object can be varied with respect to the image pickup element.

2. The portable information terminal device according to claim 1, wherein the optical unit is formed so as to protrude from the main body during photography, and so as to recede into the main body during non-photography.

3. The portable information terminal according to claim 1, wherein the optical unit is formed so as to perform variable-power operation inside the main body during photography.

4. The portable information terminal device according to claim 1, wherein the driving mechanism is formed so as to move the plurality of lenses from a dormant position to a photographic position of a wide-angle-side end through a photographic position of a telephotographic-side end.

5. The portable information terminal device according to claim 4, wherein the driving mechanism actuates a switch to turn an electric-power supply to the image pickup element on/off when the plurality of lenses are situated at the photographic position of the telephotographic-side end.

6. The portable information terminal device according to claim 1, wherein the driving mechanism has an operating portion for manually perform variable-power driving.

7. The portable information terminal device according to claim 1, wherein the main body has an extensible/contractable antenna, and the driving mechanism has an interlocking mechanism for performing variable-power driving in an interlocked manner with extension/contraction of the antenna.

8. The portable information terminal device according to claim 1, wherein the main body has a flipper openably/closably disposed to cover at least a part of a surface, and the driving mechanism has an interlocking mechanism for performing variable-power driving in an interlocked manner with the opening/closing of the flipper.

9. The portable information terminal device according to claim 8, wherein the interlocking mechanism has a connection member connected to a part of the driving mechanism and an interlocking spring for exerting an urging force by which a motion of the flipper is interlocked with the connection member.

10. The portable information terminal device according to claim 9, wherein the driving mechanism is formed so as to move the plurality of lenses from a dormant position to a photographic position of a wide-angle-side end through a photographic position of a telephotographic-side end, and the interlocking mechanism has a restriction member for restricting a movement of the connection member while overcoming an urging force of the interlocking spring when the plurality of lenses reach the photographic position of the telephotographic-side end in an interlocked manner with the opening of the flipper.

11. The portable information terminal device according to claim 10, wherein the restriction member can adjust a restricting position where a movement of the connection member is restricted in a range from the photographic position of the telephotographic-side end to the photographic position of the wide-angle-side end.

12. The portable information terminal device according to claim 11, wherein the restriction member has a cam portion for exerting a cam action onto the connection member, and an operating portion which is reciprocatively operated by hand.

13. The portable information terminal device according to claim 8, wherein the flipper is formed so as to cover the optical unit in a closed state.

14. The portable information terminal device according to claim 1, wherein the driving mechanism has an electric actuator for electrically performing variable-power driving, and a switch by which the electric actuator is turned on/off.

15. The portable information terminal device according to claim 14, wherein the main body has an extensible/contractable antenna, and the switch is switched in an interlocked manner with extension/contraction of the antenna.

16. The portable information terminal device according to claim 14, wherein the main body has a flipper openably/closably disposed to cover at least a part of a surface, and the switch is switched in an interlocked manner with the opening/closing of the flipper.

17. The portable information terminal device according to claim 1, wherein the portable information terminal device further has a camera unit that includes the image pickup element and the optical unit and that is rotatably connected to the main body, and the optical unit is formed so as to perform variable-power operation inside the camera unit during photography.

18. The portable information terminal device according to claim 1, wherein the portable information terminal device further has a camera unit that includes the image pickup element and the optical unit, and the optical unit is formed so as to protrude from the camera unit during photography and so as to recede into the camera unit during non-photography, and the camera unit is rotatably connected to the main body so as to conceal the optical unit in a retracted state.

19. The portable information terminal device according to claim 1, wherein the main body has a shielding member by which a front surface of the optical unit can be shielded, and an interlocking mechanism by which the shielding member performs a shielding motion and an exposing motion in an interlocked manner with a motion of the driving mechanism.

20. The portable information terminal device according to claim 19, wherein the driving mechanism has an operating portion for manually performing variable-power driving, and the shielding member is formed so as to be interlocked with an operation of the operating portion in order to perform the shielding motion and the exposing motion.

21. The portable information terminal device according to claim 19, wherein the driving mechanism is formed so as to move the plurality of lenses from a dormant position to a photographic position of a wide-angle-side end through a photographic position of a telephotographic-side end, and the interlocking mechanism causes the shielding member to be interlocked so as to expose a front surface of the optical unit before the plurality of lenses begin variable-power operation from the dormant position and so as to shield the front surface of the optical unit after the plurality of lenses recedes into the dormant position.

22. The portable information terminal device according to claim 19, wherein the shielding member is a shielding plate swingably supported around a predetermined shaft, and the interlocking mechanism includes:
a swinging arm that swings around a predetermined shaft in an interlocked manner with a motion of the driving mechanism;
an interlocking spring by which a motion of the swinging arm is interlocked with the shielding plate, the interlocking spring exerting an urging force in a direction in which the front surface of the optical unit is exposed; and
a restraining mechanism for restraining the shielding plate to be moved together with the swinging arm at predetermined timing when the shielding motion is performed.

23. A camera unit comprising:
an image pickup element for photographing a to-be-photographed object;
an optical unit including a plurality of lenses arranged in a direction of an optical axis, and a driving mechanism for performing variable-power driving while relatively moving the plurality of lenses so that a magnification of the object can be varied with respect to the image pickup element;
a connection terminal connected to the image pickup element for transmitting at least a signal of photographic information; and
a connector portion formed attachably/detachably to/from a portable information terminal device.

24. The camera unit according to claim 23, wherein the driving mechanism has an operating portion for manually performing variable-power driving.

25. The camera unit according to claim 23, wherein the driving mechanism has an electric actuator for electrically performing variable-power driving, and a switch by which the electric actuator is turned on/off.
